(19) United States
(12) Patent Application Publication
(10) Pub. No.: US 2024/0364960 A1
(43) Pub. Date: Oct. 31, 2024

(54) COMPUTERIZED METHOD FOR AUDIOVISUAL DELINEARIZATION

(71) Applicants: ECOLE NATIONALE SUPÉRIEURE DE L'ÉLECTRONIQUE ET DE SES APPLICATIONS, Cergy (FR); CY CERGY PARIS UNIVERSITÉ, Cergy (FR); CENTRE NATIONAL DE LA RECHERCHE SCIENTIFIQUE, Paris (FR)

(72) Inventors: Boris BORZIC, Nesles La Vallee (FR); Elmahdi SADOUNI, Ermont (FR)

(73) Assignees: ECOLE NATIONALE SUPÉRIEURE DE L'ÉLECTRONIQUE ET DE SES APPLICATIONS, Cergy (FR); CY CERGY PARIS UNIVERSITÉ, Cergy (FR); CENTRE NATIONAL DE LA RECHERCHE SCIENTIFIQUE, Paris (FR)

(21) Appl. No.: 18/577,082

(22) PCT Filed: Jul. 6, 2022
(86) PCT No.: PCT/EP2022/068798

§ 371 Date: Jan. 5, 2024

(30) Foreign Application Priority Data
Jul. 8, 2021 (FR) FR2107439

(51) Int. Cl. H04N 21/432; G06F 16/71; H04N 21/466; H04N 21/84

(52) U.S. Cl. CPC H04N 21/4325; G06F 16/71; H04N 21/4666; H04N 21/84

(57) ABSTRACT

This computerized method for audiovisual delinearization allows one or more digital video files to be sequenced and the sequences generated by the sequencing to be indexed, by virtually cutting the one or more digital video files into digital virtual sequences, each bounded virtually by two sequence time markers. The method is intended to produce and automatically select virtual sequences of each digital video file, the file fragments corresponding to the virtual sequences then being able to be extracted from the digital video files in question to be viewed or recorded in a new digital video file.

### FIELD OF THE INVENTION

The present invention relates to the field of identifying and automatically processing digital data, in particular digital video files.

More specifically, the invention relates to a computerized method for the audiovisual delinearization of digital video files.

### TECHNOLOGICAL BACKGROUND

The amount of information generated in today's society is increasing exponentially. In addition, data are made available in multiple dimensions across different digital media, such as video streams, audio streams and text streams.

This wealth of multimedia information presents significant technological challenges with regard to how the multimedia data can be integrated, processed, organized and indexed in a semantically meaningful way so as to facilitate effective retrieval.

Usually, a content structure is designed by the data producer before the data are generated and stored. To allow future retrieval based on the content, such a semantic structure (or metadata) provided must be transmitted along with the content to users when the content is delivered. In this way, users can choose what they would like according to the description of these metadata. For example, every book or magazine is published with its table of contents, via which users can find the page number (index) where the desired information is printed by simply going to that page.

Such prior indexing of highly structured content therefore allows fast access to specific parts of documents and aggregated sequences of documents to be created, such as playlists in the case of audio files.

This structuring is rarely provided in the case of video data. For example, for a movie intended for cinema, it is not common practice to provide indications allowing access to the different sequences put together by the director.

A large number of video files cannot be structured in advance. This is the case, for example, with live filmed events, for which it is not possible to predict the course of events before the digital video file has been produced.

Lastly, the indexing defined in advance by the producer might not be relevant from the point of view of the user whose search criteria are not always known in advance either.

In the case of digital video files, due to the difficulty in accessing relevant indexing, the practice is therefore to label the digital video file as a whole, such that the metadata associated with a digital video file are global, such as the name, creation date, file format, and viewing duration for example. A set of metadata makes it possible to access a digital video file as a whole when a search for audiovisual content is carried out. These metadata are therefore “global”.

It is known practice to enrich the “global” metadata associated with a digital video file with additional metadata, but these metadata are always managed at the global level of the file in order to facilitate access to the video via a search engine. For example, it is possible to retrieve information such as the director, the actors, the composer of the soundtrack of a movie or comments from viewers on the Internet, and to supplement the initial metadata with these metadata. Such enrichment allows more efficient access to a digital video file via a search engine.

To further allow access to a relevant sequence in a given digital video file, several retroactive indexing methods can be envisaged, in particular manual indexing. However, these methods are lengthy and tedious. In the field of searching for video content, the use of automatic indexing methods has become essential.

The difficulty with video content is that it is not self-descriptive, unlike text media.

Document EP3252770A1 proposes a method for automatically identifying and post-processing audiovisual content. In this method, a formal description of the content of the digital video file is provided by an operator, such as a script in the case of a movie for example. After extracting the image stream (i.e. that containing visual data) and audio stream from the audiovisual data, these two portions of the audiovisual data are decomposed into a set of successive fragments. In addition, the formal description of the digital video file is broken down into logical portions. A dialog pattern is generated from the audio stream alone. The audiovisual data are associated with the corresponding formal description by associating logical portions of the formal description with the set of audiovisual data fragments, using the dialog pattern. The digital video file can then be indexed and then manipulated based on this association.

Document U.S. Pat. No. 6,714,909B1 is another example in which a method for automating the multimodal indexing process is proposed. The method comprises the following steps:
separating a multimedia data stream into audio, visual and text components;
segmenting the audio, video and text components of the multimedia data stream based on semantic differences, the features at frame level being extracted from the segmented audio component into a plurality of subbands;
identifying at least one target speaker using the audio and video components;
identifying semantic boundaries for text for at least one of the identified target speakers in order to generate semantically consistent blocks of text;
generating a summary of the multimedia content based on the audio, video and text components, the semantically consistent blocks of text and the identified target speaker;
deriving a topic for each of the semantically consistent blocks of text based on a set of topic category templates;
generating a multimedia description for the multimedia event based on the identified target speaker, the semantically consistent blocks of text, the identified topic, and the generated summary.
The method described in document EP3252770A1 has the drawback of requiring the provision of a formal description of the digital video file. The method described in document U.S. Pat. No. 6,714,909B1 has the drawback of requiring the content of the audio and or text streams from the digital video file to be semantically structured, i.e. being able to reconstitute meaningful audio content by extracting and aggregating sequences from a given video. It cannot therefore be implemented in order to aggregate sequences derived from different video files or for semantically weakly structured video files.

The invention thus aims to provide an automated method for analyzing, indexing and editing a set of video files digitally which are optionally weakly structured based on criteria defined by the user and without prior indexing of the content of these files.

### SUMMARY OF THE INVENTION

Thus, the invention relates to a computerized method for audiovisual delinearization allowing one or more digital video files to be sequenced and the sequences generated by the sequencing to be indexed, by dividing virtually the one or more digital video files into virtual sequences by means of time marking, each virtual sequence being bounded by two sequence time markers and associated descriptors.

The method comprises the following steps:
a. receiving one or more digital video files to be analyzed;
b. indexing each of the digital video files in a primary index by means of associated primary endogenous descriptors allowing each digital video file to be identified;
c. automatically extracting audio, image, and text streams from each of the digital video files;
d. by means of a plurality of computerized devices implementing a machine learning algorithm selected and/or trained for a previously defined digital video file type, automatically analyzing, file by file, each of the digital video files, according to the four modalities: image modality, audio modality, text modality, and action modality for identifying groups of successive images forming a given action, the analysis automatically producing one or more unimodal cut time markers for each of the modalities, one or more descriptors being associated with each of the unimodal cut time markers,
e. automatically producing, at the end of the analysis of each of the digital video files, candidate virtual cut sequence time markers, with the aim of bounding virtual sequences, and descriptors associated with these candidate virtual cut sequence time markers, which are:
   either unimodal cut time markers of the digital video files, and which are referred to, at the end of this step, as unimodal candidate sequence time markers;
   or, for each of said digital video files taken individually, the time codes corresponding to the unimodal virtual cut time markers are compared and, each time at least two unimodal cut time markers resulting from different analysis modalities are separated by a time interval less than a main predetermined duration, a plurimodal candidate sequence time marker, in a mathematical relationship with the at least two unimodal sequence markers, is created;
f. for each of said analyzed digital video files, according to a defined lower bound and upper bound for determining the minimum duration and the maximum duration of each sequence, with respect to the type of the one or more digital video files,
   automatically selecting, from among the unimodal or plurimodal candidate sequence time markers, pairs of sequence markers,
   each pair having a sequence start marker and a sequence end marker, such that the duration of each retained sequence is comprised between said lower and upper bounds,
   these pairs of sequence markers being associated with the descriptors that are associated with said selected candidate sequence time markers, these descriptors then being referred to as “secondary endogenous descriptors”;
g. indexing, in a secondary index which is in an inheritance relationship with respect to said primary index, all of the pairs of sequence markers and associated secondary descriptors allowing each sequence to be identified, the virtual sequences being identifiable and searchable at least by the primary and secondary endogenous descriptors.

By virtue of these arrangements, it is possible to sequence a digital video file into sequences that have semantic consistency according to one of four different modalities, in the form of virtual sequences bounded by pairs of sequence time markers and indexed by secondary descriptors associated with these sequence time markers and primary descriptors associated with the digital video file from which the sequences are derived.

The memory space used for these sequences corresponds to the space required to store the pairs of time markers and the associated secondary descriptors. This is what makes the sequencing virtual.

According to one embodiment, the computerized method for audiovisual delinearization is characterized in that a video excerpt, associated with a virtual sequence, obtained by viewing the file fragment bounded by the two sequence markers of the virtual sequence, has a unit of meaning (in other words semantic consistency) which results from the automatic analysis of each digital video file according to the four modalities and the virtual cutting with respect to this analysis.

By virtue of this arrangement, the virtual sequences can be extracted and the video excerpts corresponding to the virtual sequences can be viewed by a user who will perceive their semantic consistency and will be able to assign them an overall meaning.

According to one embodiment, at least one of the two sequence markers of each pair of sequence markers selected in step f is a plurimodal candidate sequence time marker and is then referred to as a plurimodal sequence marker, and advantageously each sequence marker of each selected pair of sequence markers is a plurimodal sequence marker.

In this way, the overall meaning of the sequence is supported by multiple modalities, and advantageously four modalities. In the latter case, semantic consistency is therefore obtained based on all four of the text modality, the action modality, the audio modality and the image modality.

Advantageously:
the more endogenous descriptors a cut has, the greater the chance of this video excerpt being retained in the playlist following the search by the user featuring these endogenous descriptors
and the more that this large number of endogenous descriptors features common results from different modalities (plurimodal descriptors in this case), the greater the chance of this video excerpt being retained in the playlist, which will be described further on, following the search by the user featuring these endogenous descriptors.

In general, the more plurimodal the cut markers, the finer the grain size at which the video excerpts are cut.

According to one embodiment, for each video excerpt, the descriptors referred to as endogenous descriptors result from the same modality, or from one or more modalities different from the one or more modalities from which the sequence start and end time cut markers of the video excerpt result

In one particular embodiment, in step f, two types of markers of plurimodal sequence are distinguished:
a plurimodal sequence marker created from four unimodal cut time markers resulting from the four different modalities separated into pairs by a time interval less than the main predetermined duration is referred to as a primary plurimodal sequence marker, and
a plurimodal sequence marker created from two or three unimodal cut time markers resulting from the same number of modalities from among the four modalities, separated into pairs by a time interval less than the main predetermined duration is referred to as a secondary plurimodal sequence marker.

According to one embodiment, at least one of the markers of each pair of sequence markers is a primary plurimodal sequence marker.

By virtue of this arrangement, the overall meaning of the sequence is supported by four modalities.

According to one embodiment, the action modality is a modality of at least one of the two sequence markers of the selected pair of sequence markers.

By virtue of this arrangement, the semantic consistency of a sequence is at least underpinned by the action modality, which plays a particular role in many video files. For example, in the field of sport, the sequence obtained will be consistent from the point of view of sporting actions.

According to one embodiment, weights are assigned to each of the modalities for the production of the candidate sequence markers in step e and/or the selection of the sequence markers in step f.

By virtue of this arrangement, the semantic consistency of a sequence can be underpinned to various degrees, optionally adapted to video types, by the four modalities. For example, in the field of sport, a higher weight can be assigned to the action modality. In the field of online courses, a higher weight can be assigned to the text modality.

According to one embodiment,
for digital video files in the field of sport, the weight of the action modality is greater than that of the image modality, which is itself greater than the weights of the text and audio modalities,
for video files with high information content via speech, the weight of the text modality is greater than that of the three other modalities.

By virtue of this arrangement, the semantic consistency of a sequence can be adapted to a video type such as a video in the field of sport or to a video with high information content such as a documentary or an online course.

According to one embodiment, a weight is assigned to the secondary endogenous descriptors as well as to the primary endogenous descriptors to characterize their importance in the sequences, and this weight is greater for the secondary endogenous descriptors than for the primary endogenous descriptors.

The different weights of the endogenous and exogenous descriptors make it possible, when formulating a search query for searching for sequences which is formulated later on, to have these two types of descriptors play different roles. In particular, if the weight of the endogenous descriptors is greater than that of the exogenous descriptors, the results of a search for sequences will be based more on the endogenous descriptors than on the exogenous descriptors.

According to one embodiment, the secondary endogenous descriptors are said to be “unimodal” when they correspond to a single modality and are said to be “plurimodal” when they are detected for multiple modalities.

By virtue of this arrangement, it is possible to distinguish descriptors which are underpinned by just one or by multiple modalities, which can be useful during a search for a video file sequence in which it is desired to have these two types of descriptors play different roles.

To this end, according to one embodiment, information on the unimodal or plurimodal nature of a given secondary endogenous descriptor is retained during the indexing process.

For example, if the image modality gives the “thermodynamic” descriptor, and the text modality also gives the “thermodynamic” descriptor, then it is possible to form a plurimodal “thermodynamic” descriptor (which is derived from the preceding two descriptors and is therefore more robust with regard to interest in viewing this excerpt if thermodynamics is of interest).

According to one embodiment, step f of the method has these sub-steps, for each digital video file, for producing the sequences:
i) —selecting a last sequence end marker, which is in particular plurimodal, from the end of the digital video file,
   and determining the presence of a plurimodal marker with a time code comprised between two extremal time codes, which are calculated by subtracting the lower bound from the time code of the selected end marker and by subtracting the upper bound from the time code of the selected end marker,
   selecting the plurimodal marker as the last sequence start marker if the presence thereof is confirmed,
otherwise, determining the presence of a unimodal marker of which the modality is
dependent on the type of the digital video file between the two extremal codes
   selecting the unimodal marker as the last sequence start marker if the presence thereof is confirmed,
   otherwise, the last sequence start marker is designated by subtracting the upper bound from time code of the selected last end marker,
ii) reiterating step i) to select a penultimate sequence start marker, the sequence start marker selected at the end of the preceding step i acting as the last sequence end marker selected at the start of the preceding step i,
iii) reiterating sub-step ii) and so on until the start of the digital video file.

By virtue of this arrangement, convergence of the sequencing is ensured.

According to one embodiment, the main predetermined duration is less than 5 seconds, and optionally the maximum duration of each selected sequence is equal to two minutes

By virtue of this arrangement, successive unimodal cut markers are separated by at most 5 seconds, such that candidate sequence markers are fairly close together in time and the sequencing is sufficiently fine.

If the sequencing is quite fine, it is possible to form virtual sequences for which the duration is bounded by a relatively low upper bound. Thus, according to one embodiment, the duration of the selected virtual sequences is bounded by an upper bound. For example, the duration separating the two markers of a pair of sequence markers is less than 2 minutes, 1 minute or 30 seconds.

According to one embodiment, at least one additional step of enriching the indexing of the virtual sequences with exogenous secondary descriptors is carried out in step g.

By virtue of this arrangement, the sequencing can be reiterated to result in finer sequencing, since additional—exogenous—information has been added.

According to one embodiment, the secondary descriptors by means of which the identified sequences are indexed are enriched with a number or letter indicator, such as an overall score of a digital collection card, calculated for each sequence based on the secondary descriptors of the sequence and/or the primary descriptors of the digital video file in which the sequence was identified.

By virtue of this arrangement, the results of a subsequent sequence search in the secondary index can be ordered on the basis of this number or letter indicator.

According to one embodiment, the action modality comprises the sub-modalities of: {detecting scene breaks, detecting action according to digital video file type}, and each of the sub-modalities of the action modality allows a particular set of unimodal cut time markers to be generated.

By virtue of this arrangement, the same number of sets of unimodal cut time markers as sub-modalities (a modality containing no sub-modalities being counted as a single sub-modality) can be obtained, such that sequencing will make it possible to produce consistent sequences according to N sub-modalities, N being between one and the total number of sub-modalities, the sequencing being able to identify plurimodal sequence markers based on 1 to N sub-modalities. The sequencing is therefore finer and has a greater variety of points of view than in the case where the sub-modalities of one and the same modality are not distinguished.

According to one embodiment, analysis according to the audio modality comprises the detection of noise, the detection of music and/or the transcription of speech into a text stream.

By virtue of this arrangement, the various aspects of the audio modality can be taken into account in the search for unimodal cut markers.

According to one embodiment, analysis according to the image modality comprises the sub-modalities of {shape or object recognition; shot aggregation; optical character recognition}, and each of the sub-modalities of the image modality allows a particular set of unimodal descriptors to be generated.

By virtue of this arrangement, the various aspects of the image modality can be taken into account in the search for unimodal cut markers, based on the same principle as that described for the sub-modalities of the action modality.

The invention also relates to a computerized method for automatically producing an ordered playlist of video excerpts from digital video files, with a data transmission stream, the digital video files being indexed in a primary index stored in a document-oriented database containing the digital video files, with primary descriptors, the digital video files having been previously, by means of the computerized method for audiovisual delinearization according to one of the preceding embodiments, virtually cut by means of time marking into virtual sequences which are bounded by two sequence time markers, forming a pair of sequence time markers, and by associated secondary descriptors, the pairs of virtual sequence markers and the associated secondary descriptors being stored in a secondary index stored in a document-oriented database, the secondary index being in an inheritance relationship with the primary index, these indexes being accessible via a graphical interface. The computerized method for searching and automatically producing a playlist of video excerpts comprises:
1. formulating at least one search query;
2. transmitting said search query to a search server associated with the database;
3. determining and receiving, via the document-oriented database, in response to the transmitted search query, the search result which is an automatic list of pairs of sequence time markers and associated descriptors, in an order which is dependent on the descriptors associated with each virtual sequence and the formulation of the search query, the virtual sequences being identifiable and searchable by the secondary descriptors and the primary descriptors;
4. displaying and viewing, via a virtual remote control of the playlist which presents all of the video excerpts associated with the ordered automatic list of pairs of time markers received in step 3, without creation of new digital video file, the virtual remote control allowing the playlist to be browsed, each video excerpt of the playlist being associated with a virtual sequence, and being called up during the viewing of the playlist, via the data transmission stream, from the digital video file indexed in the primary index and in which the virtual sequence indexed in the secondary index has been identified.

In the computerized method for automatically producing a playlist of video excerpts,
the stored digital video files have been sequenced, and the virtual sequences from the digital video files have been indexed in the secondary index before the search criteria have been formulated and before the search result has been received by the client by means of the sequencing method as described above,
the ordered automatic playlist is a list of video sequences from the one or more digital video files each corresponding to a virtual sequence from a digital video file, in an order which is dependent on the secondary descriptors associated with each sequence and the primary descriptors associated with each digital video file.

By virtue of this arrangement, it is possible to select one or more digital video file sequences obtained at the end of the method for sequencing one or more digital video files, i.e. automatically without it being necessary for the user to view the entirety of one or more digital video files.

This selection can be made by means of a search query and the search is performed in the secondary index containing the secondary descriptors of the sequences, which is linked to the primary index containing the primary descriptors of the digital video files from which the sequences are derived.

According to one embodiment,
when determining the search result:
   in a sub-step 1), the method determines, according to the search query and the descriptors of the one or more virtual sequences, whether the virtual sequences are essential (the number of descriptors is relevant) or accessory (the number of descriptors is not relevant with respect to the criterion defined for the essential virtual sequences);
   in a sub-step 2)
   when the pairs of virtual sequence time markers constituting the automatic list are identified in just one digital video file, the method produces, via the transmission stream, either an exhaustive playlist of video excerpts that are associated with all of the essential virtual sequences, or a summary with a selection of video excerpts that are associated with the essential virtual sequences according to criteria specified by the user,
   when the pairs of virtual sequence time markers constituting the automatic list are identified in multiple digital video files of different origin, the method produces, via the transmission stream, a playlist of video excerpts that are associated with the virtual sequences, referred to as “highlights” of these digital files with a selection of the essential virtual sequences associated with the video excerpts according to criteria specified by the user.

According to one embodiment of the computerized method for automatically producing an ordered playlist of video excerpts from digital video files,
when the pairs of virtual sequence time markers constituting the automatic list are identified in a single digital video file, the method produces, via the transmission stream, a summary playlist with a selection of video excerpts from this digital video file according to criteria specified by the user during their search,
when the pairs of virtual sequence time markers constituting the automatic list are identified in multiple digital video files, the method produces, via the transmission stream, a playlist of video excerpts that are associated with the virtual sequences, referred to as “highlights” of these digital files with a selection of the video excerpts according to criteria specified by the user during their search.

According to one embodiment, the computerized method for automatically producing an ordered playlist of video excerpts allows, after automatically producing an ordered playlist of video excerpts from digital video files, the following browsing operation via the virtual remote control and the data transmission stream:
playing, stopping and resuming the excerpt during viewing of the playlist which comprises all of the video excerpts that are associated with the automatic list obtained in step 3;
targeting an excerpt in the playlist which comprises all of the video excerpts that are associated with the automatic list obtained in step 3 by fast-forwarding or rewinding;
temporarily exiting the excerpt in the playlist which comprises all of the video excerpts that are associated with the automatic list obtained in step 3 in order to view the original digital video file of the excerpt without time constraints due to the start and end markers of the virtual sequence associated with the video excerpt.

Advantageously, this comprises a single navigation bar for all of the video excerpts arranged one after the other in the playlist, in the order of the sequence markers according to the query from the user (with the descriptors associated with the cut markers in the secondary index).

By virtue of this arrangement, it is possible, based on a sequence identified as being of interest to the user with respect to their search criteria and as the user chooses, to play the rest of the file in which this sequence was identified or to switch to another sequence identified as being of interest.

According to one embodiment, the method for automatically producing an ordered playlist of video excerpts from digital video files allows the following additional operation:
d. again temporarily exiting the viewing of the original digital video file from the excerpt currently being played back since operation c), in order to view, in step d), a summary created automatically and prior to this viewing on the basis of this original digital file only.

According to one embodiment, the method for automatically producing an ordered playlist of video excerpts from digital video files allows the following additional operation:
e. recording the browsing history for the playlist of video sequences and creating a new digital file which is this browsing history.

According to one embodiment, the search query formulated in step 1 is a multicriteria search query, and combines a full-text search and a faceted search, and wherein the criteria for creating the order for the automatic playlist comprise chronological and/or semantic and/or relevance criteria.

This arrangement makes it possible to formulate search queries that are as varied as possible, including with suggestions on the basis of facets or criteria, and to obtain an ordered list of results.

According to one embodiment of the method for automatically producing an ordered playlist of video excerpts from digital video files, the search query formulated in step 1 is produced automatically on the basis of one or more criteria specified by the user selected from a list comprising: the desired duration of an automatic playlist and semantic criteria.

In this way, the search for sequences in digital video files can be entirely automated on the basis of minimal search criteria.

According to one embodiment of the computerized method for automatically producing an ordered playlist of video excerpts from digital video files, the search query formulated in step 1 is produced by a chatbot.

According to one embodiment, the computerized method for automatically producing an ordered playlist of video excerpts from digital video files comprises a viewing step in which the user views a video excerpt from the playlist on a first screen and descriptors of the virtual sequence associated with the video excerpt on a second screen synchronized with the video excerpt.

According to one embodiment, the computerized method for automatically producing an ordered playlist of video excerpts from digital video files comprises a viewing step in which the descriptors associated with the virtual sequences are viewed in the excerpts.

By virtue of these arrangements, the user can view, at the same time as the video excerpts, the descriptors on the basis of which the method considered the sequence as being relevant with respect to the search query.

In this way, the user can both assign an overall meaning to the video excerpt and compare it with the overall meaning that could be assigned thereto on the basis of the descriptors that were automatically associated with it.

According to one embodiment of the computerized method for automatically producing an ordered playlist of video excerpts from digital video files, the technology used is ElasticSearch®.

According to one embodiment of the computerized method for automatically producing an ordered playlist of video excerpts from digital video files, access to the video files takes place in “streaming” mode.

The invention further relates to an automatic list of pairs of sequence markers and associated descriptors resulting from the computerized method for automatically producing an ordered playlist of video excerpts from digital video files, with endogenous and exogenous descriptors that are consistent with the search query.

According to one embodiment, in the automatic list of pairs of sequence markers and associated descriptors resulting from the computerized method for automatically producing an ordered playlist of video excerpts from video files, all of the virtual sequences (and therefore all of the pairs of sequence time markers) have, as the sequence end marker, at least one primary plurimodal sequence marker or one derived from three modalities.

According to one embodiment, in the automatic list of pairs of sequence markers and associated descriptors resulting from the computerized method for automatically producing an ordered playlist of video excerpts from video files, the sequence end marker of each pair of sequence time markers corresponding to each virtual sequence is derived at least from the action modality.

According to one embodiment, in the automatic list of pairs of sequence markers and associated descriptors resulting from the computerized method for automatically producing an ordered playlist of video excerpts from video files, the sequence time markers are determined via a multimodal approach by automatically analyzing, file by file, each of said one or more digital video files, according to at least two of the four modalities: image modality, audio modality, text modality, and action modality.

According to one embodiment of the automatic list, at least two sequence time markers are determined randomly or unimodally.

The invention also relates to a computerized editing method with virtual cutting without creation of a digital video file, based on the computerized method for automatically producing an ordered playlist of video excerpts from digital video files, comprising the following steps:
I. automatically producing at least one ordered playlist of video excerpts from digital video files and storing the at least one automatic list of pairs of sequence time markers and associated descriptors resulting from this production step, without creating a digital video file,
II. browsing the at least one automatic playlist of video excerpts from digital video files via data transmission stream
III. the user selecting one or more virtual sequences associated with the at least one automatic playlist of video excerpts from digital video files, to produce a new playlist of video excerpts of which the order is modifiable by the user.

According to one embodiment, the computerized editing method with virtual cutting comprises the following steps:
modifying the automatic list of video excerpts by adding and/or removing video excerpts to and/or from the playlist;
modifying one or more video excerpts by extending or shortening the duration of the virtual sequences that are associated with the video excerpts of the playlist, by moving the start and end markers of each virtual sequence;
modifying the video excerpts with a visual effect or a sound effect.

By virtue of this arrangement, a new video can be edited in a highly automated manner, without manipulating digital video files in order to join them or cut them. The editing is efficient in terms of memory and computing time since it is based on the manipulation of the sequence markers.

According to one embodiment of the browsing method, the playlist of video excerpts is generated automatically by means of a computerized method for searching and automatically producing a playlist that has ordered video excerpts according to one of the embodiments described above.

The invention further relates to the use of video excerpts or of a playlist of video excerpts obtained by means of the computerized method for searching and automatically producing a playlist, or by means of the editing method according to one of the embodiments described above, in a social network or in a search engine or to produce a new digital video file.

Lastly, the invention relates to a computerized system comprising:
At least one acquisition module for acquiring one or more digital video files;
At least one distribution module;
At least one multimodal analysis module;
At least one sequencing module which generates indexed sequences of digital video files;
At least one search module comprising a client which allows a search query to be formulated
   in order to implement the following steps:
1. One or more original digital video files to be analyzed are received via the acquisition module;
2. Each of said digital video files is automatically indexed in a primary index based on the endogenous descriptors, referred to as primary descriptors, of said digital video file;
3. The audio, image and text data streams are automatically extracted from each of the digital video files;
4. By means of a plurality of computerized devices implementing a machine learning algorithm selected and/or trained for a previously defined video file type and contained in the multimodal analysis module, a file-by-file analysis is carried out on each of said one or more digital video files according to the four modalities: image modality, audio modality, text modality, and action modality, the analysis automatically producing one or more unimodal cut time markers for each of the modalities, one or more descriptors being associated with each of the unimodal cut time markers;
5. At the end of the analysis of each of the original digital video files, candidate sequence time markers are provided with the aim of bounding virtual sequences, and the descriptors associated with these candidate sequence time markers are provided, these descriptors being:
   either unimodal cut time markers of said digital video files, which are referred to, at the end of this step, as unimodal candidate sequence time markers;
   or, for each of said digital video files taken individually, the time codes corresponding to the unimodal cut time markers are compared and, each time at least two unimodal cut time markers resulting from different analysis modalities are separated by a time interval less than a main predetermined duration, a plurimodal candidate sequence time marker, in a mathematical relationship with the at least two unimodal cut markers, is created;
6. For each of said analyzed digital video files, a lower bound and an upper bound for the duration of a sequence are defined according to the type of said digital video file and pairs of sequence markers, referred to as sequence start and end markers, are automatically selected from among the candidate sequence markers,
each pair of sequence markers having a sequence start marker and a sequence end marker, such that the duration of each retained sequence is
comprised between said lower and upper bounds, these pairs of sequence markers being associated with the descriptors that are associated with said selected candidate sequence time markers, these descriptors then being referred to as “secondary endogenous descriptors”;
7. The following are indexed in a secondary index, which is in an inheritance relationship with respect to the primary index, by means of the sequencing module,
all of the pairs of sequence markers by means of the associated descriptors allowing each sequence to be identified,
the sequences being identifiable and searchable at least by the endogenous secondary descriptors and the endogenous primary descriptors;
8. A search query is formulated for searching for digital video file sequences by means of the search module;
each of the modules comprising the necessary computing means, each of the modules other than the distribution module communicating with the distribution module and the distribution module managing the distribution of the calculations between the other modules.

According to one embodiment of the computerized system, this system further comprises at least one enrichment module for enriching the primary descriptors of the digital video files and/or secondary descriptors of the virtual digital video file sequences with exogenous additional descriptors.

According to one embodiment of the computerized system, this system further comprises a video editor module communicating with the search module.

### BRIEF DESCRIPTION OF THE DRAWINGS

Embodiments of the invention will be described below with reference to the drawings, which are briefly described below:

FIG. 1 shows a flowchart of a device for implementing the method for analyzing, sequencing and indexing sequences from a digital video file.

FIG. 2a shows a first step in sequencing a digital video file according to the four modalities: image, audio, text and action.

FIG. 2b shows a second step in sequencing a digital video file according to the four modalities: image, audio, text and action.

FIG. 2c shows a third step in sequencing a digital video file according to the four modalities: image, audio, text and action.

FIG. 3 shows the various interactions between the modules and services of the computerized method in conjunction with possible user actions.

FIG. 4 shows the steps of an iteration of the method for sequencing a video file on the basis of four modalities.

FIG. 5a shows a graphical interface 55 for editing or viewing a playlist.

FIG. 5b shows another embodiment of a graphical interface for editing or viewing a playlist.

FIG. 6 schematically shows the effect of manipulating the virtual remote control on the playlist.

FIG. 7a shows a third embodiment of a graphical interface 55.

FIG. 7b shows a fourth embodiment of a graphical interface 55.

FIG. 8 shows a fifth embodiment of a graphical interface 55.

FIG. 9 shows a sixth embodiment of a graphical interface 55.

FIG. 10 shows a seventh embodiment of a graphical interface 55.

FIG. 11 shows an eighth embodiment of a graphical interface 55.

FIG. 12 shows a ninth embodiment of a graphical interface 55.

In the drawings, identical references designate objects that are similar or the same.

### DETAILED DESCRIPTION

The invention relates to a method for the multimodal analysis, sequencing and indexing of digital audiovisual data. The format of the audiovisual data is in principle not limited. By way of example, the MPEG, MP4, AVI and WMV digital video file formats from the ISO/IEC standard can be envisaged.

Audiovisual data can be available over the Internet, in a public or private digital video library, or provided individually or grouped together by a particular user.

Metadata are integrated into the audiovisual document, in particular technical metadata: compression level, file size, number of pixels, format, etc. cataloging metadata: title, year of production, director, . . . .

These metadata will be called “global” metadata insofar as they are associated with the digital video file as a whole.

In general, as will be seen below, it is not necessary for the digital video file to be structured for the method for audiovisual delinearization according to the invention to function. A digital video file without any cataloging metadata certainly can be sequenced automatically by the method according to the invention without human intervention. This is one of the strengths of the method with respect to sequencing methods of the prior art.

In particular, although the method for audiovisual delinearization can be implemented on structured digital video files, such as those used in “broadcast” methods, it is particularly relevant in the case of a digital file that is not, or is only weakly, structured, such as those available fairly generally on the Internet or used in “multicast” broadcast methods, such as YouTube® videos for example.

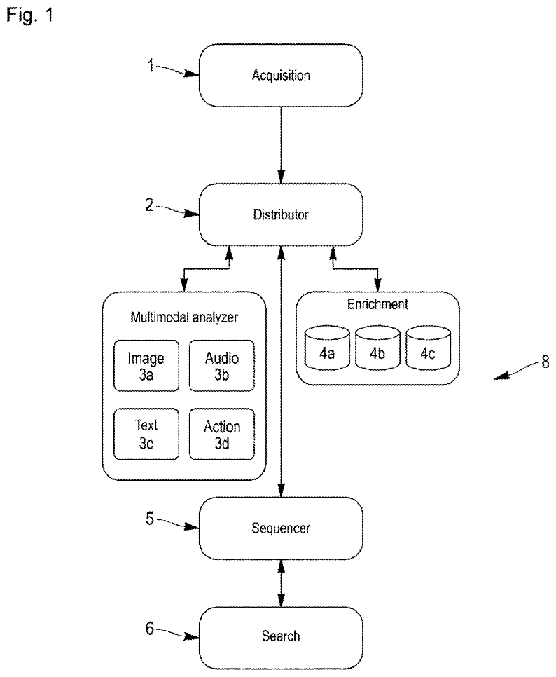

The method comprises multiple steps carried out non-linearly, requiring implementation thereof on a computerized device 8 for sequencing digital video files, an embodiment of which is shown in FIG. 1, this device comprising multiple modules:
An acquisition module 1, which allows the retrieval of one or more video files from various sources and indexing thereof by means of what are referred to as primary descriptors in a primary index;
A distribution module 2;
A multimodal analysis module 3;
An optional metadata-enrichment module 4;
A sequencing module 5 which generates virtual sequences (or virtual fragments) from the one or more digital video files and indexes them in a secondary index by means of secondary descriptors;
A search module 6, which comprises the client that allows searching the sequences generated by the module 5 for one or more digital video files.
Optionally, an enrichment module 4.
Optionally, a video editor module 7 which comprises a graphical interface that allows manipulation of virtual sequences produced following a search for virtual sequences by the module 5.

The term “virtual sequence” or, equivalently, “virtual fragment” of a digital video file will be used. A virtual sequence of a digital video file (for the sake of simplicity hereinafter: digital video file sequence, or just sequence) refers to a virtual fragment of the initial digital video file, of shorter duration than the initial file, wherein the series of images between the start and the end of the fragment is exactly the same as that of the initial digital video file (or original digital video file, or in any case the one in which the virtual sequence was identified), between the corresponding two times, without a new digital video file specific to the sequence being created at the physical level.

A virtual sequence of a digital video file is therefore formed only by the data of a pair of sequence time markers, comprising a sequence start marker and a sequence end marker.

Each time marker corresponds to a particular time code in the initial digital video file.

When a virtual digital video file sequence is identified, only the pair of corresponding sequence time markers, and the descriptors allowing it to be indexed and thus the virtual sequence to be accessed via an index search, are stored in a memory, for example in a document-oriented database.

A digital video file virtual sequence is therefore indexed systematically by means of one or more semantic descriptors, referred to as secondary descriptors

The storage memory space used to store these “virtual” sequences corresponds to the space required to store the pairs of time markers and the associated secondary descriptors. This is what makes the sequencing virtual.

In other words, it is not necessary to create a new digital video file per virtual sequence, which would be a copy of a fragment of the initial digital video file in which the sequence was identified.

The sequencing and indexing method according to the invention is therefore particularly inexpensive in terms of memory.

A digital video file virtual sequence makes it possible, in a second step, in particular according to the needs of the user, to extract a “real” fragment from a digital video file, i.e. to create a digital video file “video excerpt”.

The creation of a digital video file video excerpt can, for example, take the form of modifications in the random access memory of a processor by viewing the content between the two sequence markers of the selected virtual sequence, in particular via streaming, in particular after a decompression step. This viewing of the video excerpt does not require the creation of a new digital video file and directly calls up the passage or fragment of the original digital video file by virtue of the virtual sequence.

The creation of a video excerpt can optionally, in some cases, take place in a storage memory via storage of the digital video file fragment associated with the virtual sequence in the form of a new digital video file which can be smaller in size than the digital video file in which the corresponding virtual sequence was identified.

The acquisition module 1 allows one or more digital video files that it is desired to analyze to be copied from various storage sources and to be stored in a suitable storage device.

The storage device potentially contains other files that has already been acquired and its content increases as the device is used. Preferably, the storage device allows the video file to be accessed in “streaming” mode.

In particular, it is possible to download thematic videos to be analyzed via Web connectors, based on a search query formulated in an Internet search engine. It is also possible to copy all or some of the digital video files from another storage device, such as a USB key or an archive server, for example.

All of the digital video files acquired by the module 1 can be homogeneous or heterogeneous from a content point of view.

For example, it is possible to envisage acquiring digital video files based on a date criterion, such as all of the video files filmed on a specific day. In this case, there would in principle be no reason for the digital video files all to be homogeneous from a content point of view.

In another case, one or more digital video files can be acquired based on a combination of keywords. For example, it is possible to envisage acquiring all of the digital video files corresponding to the Ligue 1 soccer matches in France for a given year. All of the files then have content related to soccer.

By way of example, the operation of the method will be described a number times with respect to this particular case of soccer. It is important to note that this example, which is homogeneous in the sense defined above, is in no way limiting and serves only to help with understanding of the method.

The method can be implemented in any field (sport, online courses, scientific conferences, televised news, amateur video, cinema, etc.) or even in multiple fields at the same time. This will be referred to as the field, or equivalently type, of the digital video file. A field or type can in particular be described using semantic descriptors.

The various modules consist of physical or virtual machines, and therefore of one or more processors. The machines are organized into clusters. The device comprises at least one master node which interacts with a plurality of “worker” nodes. Each of the master and worker nodes encapsulates at least the applications, storage resources, and computing means required to carry out the one or more tasks to which it is dedicated.

Any container orchestration solution that allows the deployment and scaling of the management of containerized applications to be automated can be envisaged for the production of this cluster. By way of non-limiting example, the open-source ElasticSearch® technology can be used.

The digital video files acquired by the module 1 are therefore stored, for example in a document-oriented database, and they are additionally indexed in what is referred to as a “primary” index, allowing each of the digital video files to be retrieved and accessed as a whole.

The primary index is, for example, contained in the document-oriented database.

The indexing of a given digital video file in the primary index is performed by means of what are referred to as “primary” descriptors. These are, for example, all or some of the metadata of the digital video file.

The database is a document-oriented database, as opposed to a relational database, in the sense that searching in the database is not based on a relational model or limited to an SQL based on algebraic operators, as will be described later on.

Each digital video file acquired by the acquisition module 1 is transmitted to the distribution module 2, which is a master node. The distribution module 2 receives and distributes queries to the worker nodes that are suitable for executing the queries and available to do so.

Potential worker node redundancies could be envisaged but will not be described in detail here.

After receiving a digital video file, if the metadata of the digital video file allow it, the distribution module 2 can initiate a prior optional step of enriching the metadata in the enrichment module 4.

The enrichment module 4, which is a worker node, is in particular connected to external databases, such as open-data databases (4a), Web services (4b) or other, private, databases in particular.

For example, from the metadata of a digital video file for a soccer match containing information on the date, location and teams present, it is possible to envisage retrieving, by virtue of the enrichment module 4, data such as the names of players, kit colors, or even a possible text description of the match if one exists. However, this prior step is not essential for the implementation of the method and it is possible for it not to be executed or not to result in any actual enrichment of the metadata initially associated with the digital video file.

The method is based on techniques for automatically delinearizing the digital video file based on the content. What is meant by delinearization is uncovering and/or recognizing underlying structures in a digital file, in particular a digital video file, without human intervention. Delinearization is, in the context of the invention, based on the content of the digital file, including the metadata, whether or not enriched beforehand.

Just after the acquisition of the digital video file or after the prior step of enrichment, the distribution module 2 can first trigger four analyses in the multimodal analysis module 3.

The multimodal analysis module 3 is a “worker” node in which four different computerized devices, each implementing a machine learning algorithm, are implemented.

These are, for example, four different neural networks. These neural networks analyze the digital video file from different points of view in parallel.

Each of these neural networks is appropriately selected to extract potential cut time markers from the digital video file into sequences exhibiting consistency, i.e. a meaning, with respect to a particular analysis point of view.

The image stream (or, equivalently, video stream) of the digital video file can be considered, inter alia, as an ordered collection of images. It is therefore possible to assign an order number to each image, allowing it to be retrieved within the digital video file.

Within the meaning of the invention, a time marker corresponds to an order number, or equivalently to a given moment in time in the viewing of the video, the times being traceable back to the initial time corresponding to the first frame of the digital video file. In particular, a cut marker is associated with a time code.

The neural networks used can in particular be convolutional neural networks (CNNs) and/or recurrent neural networks.

Each of these neural networks contains multiple successive layers of neurons, so as to be able to undergo an unsupervised, semi-supervised or supervised deep learning phase, and is preferably pre-trained before it is implemented in the device 8.

The role of supervision can be more or less important depending on the analysis modality. For example, the analysis of the text and sound streams could, in one non-limiting embodiment, be carried out by a neural network that has undergone an unsupervised learning phase, and the analysis of the image stream could implement a neural network that has undergone a supervised or semi-supervised learning phase.

The number and type of layers are selected according to the type of analysis to be carried out.

A digital video file comprises components (also called “streams”) images (or, equivalently, video), sound (or, equivalently, audio) and text placed in a container. A digital video file optionally contains multiple audio streams and/or multiple image streams.

The text stream comprises elements such as metadata, subtitles, the transcription of the audio stream into text when possible, etc.

It is possible to analyze each of these components, or streams, of the file separately.

The first neural network, called the image modality analyzer (3a), is configured to carry out an analysis on the image stream, image by image. It can in particular carry out the following types of analyses: object, shape, color and texture detection, similar image detection, optical character recognition, etc.

The image modality analyzer (3a) analyzes the content of each image of the file to be analyzed, pixel per pixel. It is, inter alia, provided with an object detection algorithm, which is preferably capable of analyzing a video stream in real time while maintaining good predictive performance (the “Yolo3” algorithm for example).

The image modality analyzer (3a) extracts a set of primitives that take into account certain aspects such as outline, texture, shape and color, and then aggregates the results into a single signature that allows similarity calculations, in particular through a hybridization of deep learning and unsupervised clustering algorithms (k-nearest neighbors, KNN).

From a set of primitives relating to outline, texture, shape and color (shape recognition), the algorithm aggregates the results into a signature that allows similarity calculations, in particular through a hybridization of deep learning and unsupervised clustering algorithms (KNN) (shot aggregation).

It is also provided with a functionality for searching for symbols such as emoticons for example, which can be added to the digital video file before it is analyzed through interaction with the user.

In one particular embodiment, the image modality gives rise to an analysis according to at least three sub-modalities:
Object, shape detection
Recognition of text in images (timers, scores, text on players' kit, text in presentation slides for teaching, etc.) and analysis of this text (optical character recognition)
shot aggregation: similar shots detected in images analyzed one by one are grouped together.

The second neural network is a network referred to as a sound analyzer (3b) or, equivalently, audio modality analyzer. It is equipped with an audio track separator and a speech, noise, music, etc. activity detector.

It allows the audio stream to be analyzed by, for example, detecting sequences of music, dialog or at least speech, noise, silence, or detecting sound environments . . . .

The third neural network (3c) is an analyzer of the text stream or, equivalently, text modality analyzer, for example detecting metadata, subtitles when they are available, or text obtained after extracting speech-to-text text using known voice recognition technologies, or “video tagging” information as described later on.

On the basis of NLP (natural language processing) algorithms implemented on the text (e.g. speech-to-text transcription), the text modality analyzer (3c) cuts sentences and paragraphs into units of meaning reflecting a change of subject or the continuation of an argument based on speech analysis models.

The text mode analyzer (3c) can also, via an, optionally open-source, natural language processing (NLP) platform, extract semantic metadata to populate structured fields from the full text from the module 4, for example from Web sources and/or social networks.

The fourth neural network (3d) is an analyzer of the video stream as a whole in order to create cut markers based on dynamic concepts, such as the concepts of action or scene changes. This analysis modality will equivalently be referred to as the action modality or event modality.

The role of this action modality analyzer (3d) is to define a type of actions for the digital video file to be analyzed, optionally without prior knowledge of these actions.

In the example of table tennis, the actions could include the phases of actual play as opposed to phases during which the players do not play, for example: waiting for the next serve, collecting the ball, . . . .

Precise actions, such as a forehand or an offensive or defensive backhand can be identified.

The action modality analyzer (3d) first detects scene breaks. It should be noted that scene breaks are generally not inserted at random by an editor, and they can therefore carry a lot of information, which is at least partially retrieved by virtue of this detection of scene breaks. The images characteristic of each scene are then sent to the image modality analyzer (3a). Next, the information returned by the image modality analyzer (3a) is analyzed in the action modality analyzer (3d) by an action detection algorithm.

For example, a dense pose estimation system can be implemented, which associates the pixels of two successive images based on the intensities of the different pixels in order to match them with one another.

Such a system can perform “video tracking” without sensors having been positioned on the moving objects/subjects present in the video content. It is possible in particular to detect parts of the human body and therefore to follow the path of a soccer player, for example.

A library of actions can be put together with a view to a supervised learning phase, in particular by virtue of this estimation. In the example of table tennis, analyzing the motion of the player's arm across a set of digital video files each containing a sequence of well-identified offensive forehands allows the neural network to recognize, on the basis of the successive positions of a player arm, an offensive forehand in a video file that was not used for learning.

An offensive forehand (topspin), which is performed from the bottom upward, is, for example, different from a defensive forehand (backspin), which is performed from above downward.

Actions can be defined outside the context of the sport. In the field of political news, a handshake between two people can be an action within the meaning of the invention, and a neural network can learn to recognize such an action.

In the field of education, a teacher writes on a board can constitute an action.

The action modality analyzer (3d) can also make use of the sound associated with the images. Thus, for educational videos, an interruption in the flow of a speaker might be indicative of a change of action in the sense of these videos, i.e. the transition from a sequence of the course to another sequence.

The action modality analyzer (3d) can also make use of “video tagging” information, i.e. keyword-based metadata added manually to the digital video file, when they are relevant from the point of view of the actions that have been identified.

In one particular embodiment, the action modality gives rise to at least two sub-modalities:
The first sub-modality is the analysis (or equivalently detection) of scene breaks
The second sub-modality is the detection of action in the sense of a type, such as a digital video file type or gesture or motion type.

The method can include the phase of the neural networks learning from a set of video files associated with a particular field, for example a set of video files relating to a particular sport, or to a particular scientific field. It can also be implemented on previously trained neural networks for a field selected by the user for example.

At the output of the multimodal analysis module 3, at least four sets of unimodal cut time markers, each resulting from a modality, or even a sub-modality of a modality, can be provided for the digital video file, each of the unimodal cut time markers being associated with a set of semantic descriptors, referred to as unimodal endogenous descriptors.

It will be recalled that, in particular, the image (3a) and action (3d) modality analyzers can provide sets of unimodal cut time markers according to multiple sub-modalities. For example, different unimodal cut time markers can be identified according to one or more of the sub-modalities:
scene breaks,
shot aggregation (by similarity, for example from the same camera)
object, shape detection,
optical character recognition.

If sub-modalities are distinguished, it is therefore possible to obtain more than four sets of unimodal cut time markers.

It is of course also possible to reduce the number of analysis modalities or sub-modalities in order to provide fewer than four sets of unimodal cut time markers. In this case, the sequencing will be coarser.

Within the meaning of the invention, a descriptor is a term and can be a common noun or proper noun, an adjective, a verb, an expression, a compound word or a group of words, and represents a concept. Only descriptors or combinations of descriptors can be used for indexing. Non-descriptors can, however, be used in formulating the search query in the search and editing module 6.

The descriptors can optionally be defined in a thesaurus specific to the device or come from existing thesauri. A descriptor therefore makes it possible, in a documentation language, to specify the content of the digital video file when it is associated with the digital video file in its entirety, or a digital video file sequence when associated therewith.

The analysis step can be carried out on the basis of minimal metadata.

The following schematic example facilitates understanding of the various steps of the method. It is assumed that a user of the device wishes to analyze a video:
that they have no prior knowledge of, and that they do not wish to view beforehand
for which they only have a meaningless file name
the audio track of which does not allow meaningful text content to be extracted. For example, it contains only noise without identifiable speech, or background music without speech and unrelated to the image content.

Typically, the digital video file is a “example 1” amateur video file, produced during a soccer match in a very noisy sound environment so that no words can be detected in background noise.

A first analysis by the multimodal analysis module 3 brings to light a few descriptors relating to ball, soccer, kit (and colors), names of certain players, and soccer stadium sound environment, which correspond to a relatively coarse sequencing after processing of the results from the multimodal analysis module 3 by the sequencing module 5, which will be described later on.

The distribution module 2 can optionally enrich the unimodal descriptors identified and associated with the unimodal cut time markers with exogenous descriptors, either by transmitting them to the enrichment module 4, or by using the descriptors already identified and stored in the device itself, in particular in the primary and secondary indexes.

In the case of example 1, in an Internet search for data containing the keywords “ball, soccer, player names”, additional descriptors, or equivalently exogenous descriptors, such as “match, goal, half-time, etc.” could be added. Such exogenous descriptors can also be found in the database of the device if it has already analyzed other soccer match video files.

If the enrichment module 4 is involved, the distribution module relaunches a step of the multimodal analysis module 3 carrying out an analysis on the basis of these enriched descriptors. This new step generates unimodal cut time markers that are more numerous and/or more appropriate for the video analyzed. For example, a second step of analyzing the “example 1” video following the enrichment of the descriptors by the enrichment module 4 will make it possible to obtain sequencing based on the two halves of the game and goals scored if these events are identified.

The multimodal analysis module 3 used initially can be “generalistic”, i.e. suitable for digital video files of which the content is as varied as possible, or else specialized via learning from an ad hoc set of videos.

If it is desired to analyze videos from the point of view of sports, a multimodal analysis module 3 dedicated to and trained for this field, or even for a specific sport, can be implemented. However, it is possible to analyze the same video with several multimodal analysis modules 3 dedicated to several different fields to obtain different sequencing, or to use a set of modules 3 to change the multimodal analysis module 3 selected as the metadata are enriched in order to transition toward a multimodal analysis module 3 that is increasingly more suited to the content of the digital video file, for which the device had no prior knowledge of the field of the content.

In the latter case, redundancy of the multimodal analysis module 3 is therefore necessary, each of the multimodal analysis modules 3 being adapted to a particular field and/or generalistic.

In one particular embodiment, the multimodal analysis module 3 can analyze the file only in two modalities, for example if one of the streams of the file is not usable, or if these two modalities are to be favored.

At the end of a step in the multimodal analysis module 3, and an optional intermediate enrichment step in the enrichment module 4, the unimodal cut time markers and the associated unimodal endogenous, and optionally exogenous, descriptors are transmitted by the distribution module to the sequencing module 5.

The sequencing module 5 is itself also a “worker” module. The sequencer summarizes all of the information collected by the distribution module to create homogeneous, consistent and relevant sequences, if possible according to several of the points of view used in the multimodal analysis module 3 at the same time.

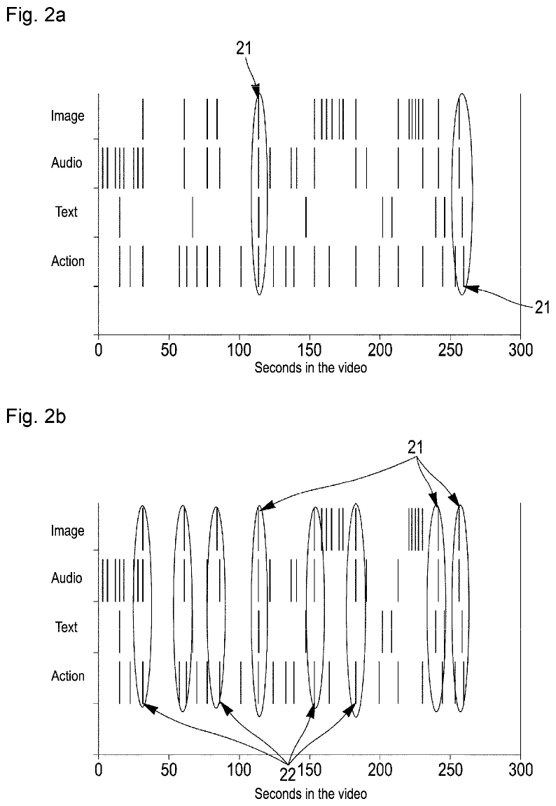

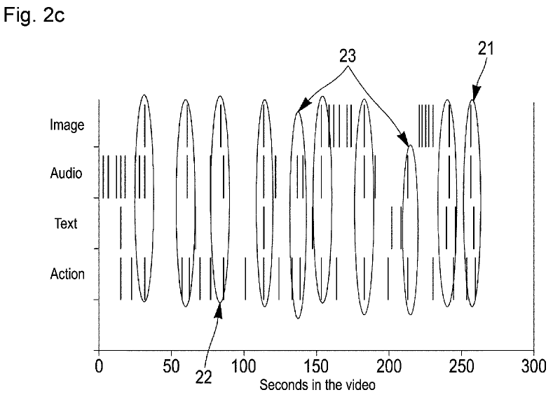

In the example shown in FIG. 2a, FIG. 2b and FIG. 2c, the horizontal axis represents the time axis for the digital video file, i.e. the order of appearance of the different images that make it up, the unimodal cut time markers associated with the image modality are, for example, shown on the top line, the unimodal cut time markers associated with the audiovisual modality on the line just below, the unimodal cut time markers associated with the text modality below that, and finally the unimodal cut time markers associated with the action modality are shown at the bottom.

At the end of sequencing, the sequencing module 5 proposes candidate sequence time markers.

A candidate sequence time marker is:
either a multimodal candidate sequence time marker,
or a unimodal candidate sequence marker.

A multimodal candidate time marker is created as follows: if at least two unimodal cut time markers resulting from different modalities are identified as being close together in time, a plurimodal candidate time marker, in a mathematical relationship with these unimodal cut time markers, is created.

Closeness in time is defined with respect to a previously specified time criterion T2: two (or more) unimodal cut time markers are considered to be close together in time if they are separated pairwise by a duration less than a predetermined duration T2, called the main duration.

A plurimodal time marker is created in a mathematical relationship with the unimodal cut markers which underpin its creation according to a previously set rule.

For example, the candidate plurimodal sequence marker is identical to the unimodal cut time marker from the audio modality. Else, it can correspond to the time marker closest to the average of the time codes of the n unimodal cut time markers identified as being close together in time.

With regard to a unimodal candidate sequence time marker, it is created on the basis of a single modality. In this case, it is referred to as a unimodal candidate sequence time marker and is identical to the identified unimodal cut time marker.

FIG. 2a shows the decomposition of a digital video file according to the four modalities: image, audio, text and action.

In this figure, two plurimodal candidate sequence time markers 21 are detected in this case with four modalities.

When all four modalities have identical time codes or time codes evaluated as being close, what is referred to as a primary candidate sequence marker, since it originates from all four modalities, is detected. Candidate sequence markers are therefore referred to as “primary” candidate sequence markers when they originate from all four modalities. The two candidate sequence time markers 21 of FIG. 2a are therefore primary plurimodal candidate sequence time markers.

Plurimodal endogenous descriptors, referred to as “primary” endogenous descriptors since they originate from all four modalities, are associated with each of the identified primary plurimodal candidate sequences 21.

FIG. 2b shows the decomposition of the same digital video file as in FIG. 2a according to the four modalities: image, audio, text and action.

This decomposition first results in the detection of three primary candidate sequence time markers 21, originating from four different modalities.

Candidate sequence time markers 22 which are plurimodal but derived only from three modalities can be identified.

When three modalities have identical time codes or time codes evaluated as being close, a sequence marker is identified. This plurimodal candidate sequence marker is referred to as secondary, since it is plurimodal but originates from fewer than four modalities. The secondary plurimodal candidate sequence marker is associated with what are referred to as secondary plurimodal endogenous descriptors, since they are plurimodal but originate from fewer than four modalities.

Whatever the case, a plurimodal candidate sequence marker, whether primary or secondary, can be associated with multimodal (or, equivalently, plurimodal) endogenous descriptors, which are derived from the unimodal descriptors associated with the unimodal cut time markers of all of the modalities that allowed the plurimodal marker to be selected.

The descriptors are referred to as “endogenous” when they result from the sequencing of the digital video file by the sequencing module (5) but not from a step of enrichment, by the module (4), from information exogenous to the digital video file.

Four secondary plurimodal candidate cut time markers 22 originating from three modalities can be seen in FIG. 2b.

When only two modalities have identical time codes or time codes evaluated as being close, with a proximity threshold possibly being predetermined, a “secondary” plurimodal candidate cut marker, since it is plurimodal but originates from fewer than four modalities, is identified, with which “secondary” endogenous multimodal descriptors, since they are plurimodal but originate from fewer than four modalities, are associated, in a second step.

This case is shown in FIG. 2c, still for the same digital video file as in FIG. 2a. The sequencing first allows primary plurimodal candidate sequence markers 21 to be detected, then secondary plurimodal candidate sequence markers 22 from three modalities, and then secondary plurimodal candidate sequence markers 23.

Preferably, the plurimodal candidate cut markers are therefore first selected by proximity in time across four modalities, which results in the choice of primary plurimodal candidate sequence markers 21.

If the criterion of proximity in time across at least four different modalities or sub-modalities results in insufficient sequencing, secondary plurimodal sequence markers 22 or 23 can be selected based on the association of two or three modalities.

Sequencing is considered to be “insufficient” based on criteria that can be evaluated automatically. For example, if at least one time interval separating two successive candidate sequence markers has a duration greater than a predetermined duration, referred to as the threshold duration T1, which is defined, for example, relative to the total duration of the digital video file or in an absolute manner, then the sequencing is insufficient.

Once the candidate sequence time markers have been identified, a selection is made from among these candidate sequence markers to form one or more pairs of sequence markers, each comprising a sequence start marker and a sequence end marker.

In one embodiment, the duration of a sequence is, for this purpose, bounded by a minimum duration D1 and by a maximum duration D2 which are dependent on the type of the digital video file to be sequenced.

Next, to initialize the formation of pairs of sequence markers, a last sequence end marker can be placed after the end of the digital video file, either exactly at the end of the file, or, for example, at the location of a candidate sequence time marker provided that it is separated by a time interval less than a predetermined threshold from the end of the file.

Next, it is possible to consider carrying out iterations of the following steps:
A plurimodal candidate sequence marker separated by a duration between the durations and D1 and D2 of the last sequence end marker is sought. If one exists, it is effectively retained as the last sequence start marker and associated with the last sequence end marker in order to form the last pair of sequence markers, which bounds the last virtual sequence.

If a plurimodal candidate sequence marker is less than D1 from the last sequence end marker, it might then be decided not to retain it because the sequencing would result in sequences that are too short for them to really be of interest.
Otherwise, if no plurimodal candidate sequence marker is identified below the duration D2, a unimodal candidate sequence marker separated by a duration between the durations and D1 and D2 of the last sequence end marker is sought. If one exists, it is selected as the last sequence start marker and associated with the last sequence end marker in order to form the last pair of sequence markers, which bounds the last virtual sequence.
Otherwise, a last sequence start marker is created, separated by a duration D2 from the identified cut marker, so as to ensure convergence of the process.
Next, the search process is reiterated in order to select the penultimate sequence start marker, the last sequence start marker acting as the penultimate sequence end marker in the algorithm described just above.
And so on until the start of the digital video file is reached.

Each time a pair of sequence markers comprising a sequence start marker and a sequence end marker is formed, a sequence is therefore virtually formed.

In one particular embodiment, at least one of the sequence markers of each pair of sequence markers is plurimodal. Optionally, the two sequence markers of each pair of sequence markers are plurimodal.

This arrangement ensures that the identified sequences exhibit semantic consistency defined by multiple modalities.

In one particular embodiment, still with the aim of increasing the fineness of the sequencing while maintaining high semantic consistency, at least one of the sequence markers of each pair of sequence markers is a primary plurimodal sequence marker.

In one particular embodiment, weights can be assigned to the different modalities according to the type of the digital video file. For example, for “sports” videos, the action modality can play a greater role in sequencing if its weight is higher.

The weights of the various modalities can optionally be chosen according to the nature of the content analyzed (known beforehand or detected with increasing iterations) and/or according to the search criterion for searching for video files formulated by a user of the device 8.

Each digital video file virtual sequence can be indexed in a secondary index by means of the endogenous descriptors, and if applicable exogenous descriptors, that are associated with the sequence start marker, as well as those associated with the sequence end marker.

The descriptors associated with the sequence start marker and/or with the sequence end marker are referred to as “secondary” descriptors in the sense that they are associated with a digital video file sequence rather than with the digital video file as a whole. They allow the pair of sequence markers to be indexed in the secondary index.

The secondary index is in an inheritance relationship with the primary index such that the primary endogenous descriptors, associated with the digital video file, are also associated with the identified sequence.

The inheritance relationship is to be understood in the computing sense, in particular that of object-oriented programming: the sequences of a digital video file are “daughters” of this digital file in the sense that if the digital video file is indexed by means of primary endogenous descriptors and, if applicable, exogenous descriptors, the sequence inherits these primary descriptors and can therefore be searched in the index not only on the basis of the secondary descriptors which characterize it but also on the basis of the primary descriptors which characterize the digital video file of which it is the “daughter”.

Alternatively, the minimum duration of a video file sequence is not set in principle but a video file sequence (or equivalently a pair of sequence time markers) is retained in the secondary index only if it is associated with a sufficient number of descriptors, for example so that there is a significant chance of finding this sequence at the end of a search query.

As seen above, in the event that it is not possible to find plurimodal sequence markers, unimodal sequence markers can be selected, before an enrichment step and a new iteration of the sequencing process for example.

The unimodal sequence markers then play the same role as plurimodal sequence markers in the indexing process, i.e. the corresponding sequences are indexed on the basis of the associated unimodal descriptors. This scenario is not sought per se, but ensures convergence of the sequencing process.

According to one embodiment, information on the unimodal or plurimodal nature of a given secondary endogenous descriptor is retained during the indexing process.

By virtue of this arrangement, it is possible to distinguish plurimodal secondary descriptors from unimodal descriptors, which can be useful during a search for a video file sequence in which it is desired to have these two types of descriptors play different roles.

In one variant, rather than a digital video file being analyzed in reverse, it starts by selecting a first initial sequence marker, then a first sequence end marker and so on until the file has been fully traversed starting from the start of the file.

At the end of the video breakdown, or delinearization, process that it performs, the sequencer therefore indexes, in a secondary index, all of the validated virtual sequences, i.e. all of the virtual sequences that have been identified and bounded by a sequence start marker and a sequence end marker which have been retained by the sequencing module 5, each of these markers being associated with a set of endogenous and, if applicable, exogenous secondary semantic descriptors.

It should be noted that a sequence time marker can be associated by default with the first image and/or with the last image, so as to ensure that the entire file is sequenced.

It should also be noted that a preliminary step of reducing the digital video file can be carried out so as to perform sequencing only on the digital video file fragments that are of interest.

It is possible, for example, to envisage automatically removing, by virtue of specialized neural networks, fragments corresponding to advertising sequences, or fragments from an amateur digital video file that are too dark to be worth retaining. This step helps to decrease the time taken to sequence the file.

The secondary descriptors selected at the end of the sequencing step are secondary because rather than being associated with a digital video file in its entirety, like “global” metadata or generally like “primary” descriptors, they are associated with a particular sequence.

The sequencing module 5 can optionally be a cluster of sequencers, this arrangement allowing queries to be distributed across the different sequencers of the cluster according to increasing load on the device.

The process is iterative, i.e. the secondary descriptors associated with a virtual sequence can be enriched by searching for “exogenous” secondary descriptors, such as sequence descriptors already present in the database of descriptors of the device and/or through the enrichment module 4, before a new sequencing operation is initiated in order to result in finer sequencing, on the basis of the endogenous and exogenous primary and secondary descriptors identified.

It is also possible, before sequencing a digital video file, to perform a step of enriching the primary endogenous descriptors of this digital video file with exogenous descriptors, also referred to as being “primary” exogenous descriptors, by means of the enrichment module 4. A digital video file is therefore indexed in the primary index by means of endogenous primary descriptors and, if applicable, exogenous primary descriptors.

According to one embodiment, information on the exogenous or endogenous nature of a given primary or secondary descriptor is retained during the indexing process.

By virtue of this arrangement, it is possible to distinguish endogenous descriptors from exogenous descriptors, which can be useful during a search for a video file sequence in which it is desired to have these two types of descriptors play different roles.

In the case of “example 1”, if the sequences were bounded at the end of a first sequencing step on the basis of the time noted for goals and half-time, it is possible, for example, to retrieve the corresponding match from the Internet and to enrich the endogenous secondary descriptors of each sequence based on text information on this match.

A new analysis by the multimodal analysis module 3 and more refined sequencing by the sequencing module 5 can then be carried out.

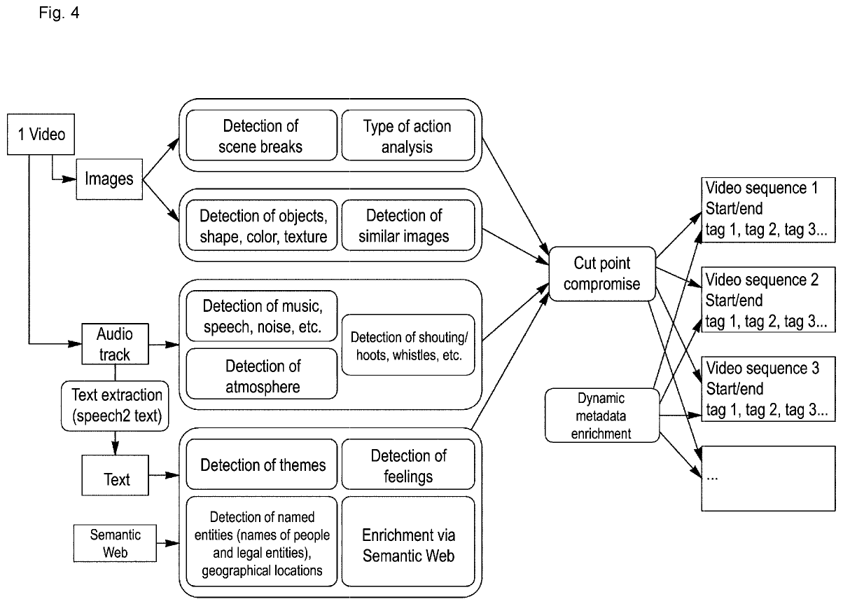

FIG. 4 schematically shows the steps of an iteration of the method for sequencing a video file on the basis of four modalities.

These steps back and forth between the multimodal analysis module 3 and sequencing module 5, orchestrated by the distribution module 2, can be repeated in a controlled manner either on the basis of limiting the number of iterations, or on the basis of sufficiently fine sequencing of the digital video file.

It is, for example, possible to stop the process when at least one candidate sequence marker has been identified for any specified time interval t, of a few seconds for example.

It has been seen that the digital video files acquired by the module 1 were indexed in what is referred to as a “primary” index, allowing access to the digital video file as a whole. The sequencing module 5 indexes the sequences identified from the digital video file in an index referred to as the “secondary” index.

The process of indexing the digital video file sequences is a parent/child process: the index of the distribution module points to the general information on the digital video file, thus to the “primary” index, while the sequencer creates an inherited “secondary” indexing.

In one embodiment, the primary and secondary indexes are multiple-field indexes and feed each other on each iteration.

For example, a step of sequencing the video of a soccer match can give rise to N sequences, the kth of which is associated with a “half-time” descriptor. The “half-time” information is relevant both for sequence k and for the entire video file. The primary indexing of the video file can therefore be enriched with the half-time information and the time of this half-time in the file.

In a second iteration of the sequencing, if, for example, it is known that three goals are to be sought and that these four goals are found before the first half, which information is contained in the primary index, it will be possible to associate any sequences from the second half that come close to a goal with offensive actions without a goal actually being scored. The secondary index is then enriched with this information. And so on.

In summary, information of a generic nature can feed the primary index from the secondary index, and information initially identified as generic but which becomes particularly relevant to a particular sequence can feed the secondary index from the primary index.

The invention therefore makes it possible, by virtue of this indexing process, to reach a much finer grain size in a search for content in digital video files that is permitted by the indexing processes currently implemented for this type of file, as well as making it possible to search for sequences at two levels according to the two nested dimensions created by the two indexes.

It will be understood that after at least one pass through the multimodal analysis module 3 and the sequencing module 5 followed by a step of enrichment of the descriptors via the distribution module 4, automated indexing of the sequences identified in the digital video file—“secondary” indexing—can be obtained without any prior knowledge of the content of this digital video file, even if the audio and text content does not allow relevant descriptors to be obtained at the outset.

It will be clearly understood that this secondary indexing is dynamic, i.e. that it can be enriched and refined: as videos in the same field are analyzed; the body of relevant descriptors associated with this field on the basis of which the multimodal analysis module 3 can analyze a digital video file increases. As a result, the first digital video file analyzed can be re-analyzed after the analysis of N other digital video files in order to refine its sequencing.

It will also be understood that the secondary indexing can be carried out according to various points of view depending on the video search queries performed by the user on the already analyzed video library. In other words, an initial point of view chosen for the secondary indexing is not definitively limiting and can still be modified based on a particular search.

For example, a digital video file might have been created manually by aggregating two video files to result in a digital video file containing a soccer sequence that contains, inter alia, a spectacular soccer goal followed by a rugby sequence that contains, inter alia, a spectacular rugby try. The analysis of this digital video file in sports mode would give two sequences, a sequence (a) for soccer and a sequence (b) for rugby, but there is no reason for the sequencing to be adapted to soccer instead of rugby or vice versa.

If, during a search via the search module 6 described later on, based on keywords associated with soccer, sequence (a) is presented among the search results among other videos, the distribution module can restart analysis of video (a) based on descriptors adapted to soccer, in order to obtain sequencing and indexing more adapted to this particular sport. However, it can still carry out the same process again at another time for the case of rugby.

This indexing is therefore dynamic indexing that does not require prior knowledge of the content of the digital video file and is refined and enriched as the device is used.

Once the iteration stop criterion has been met for at least one digital video file, the search module 6 contains a “client”, which allows a user to access the various sequences of the video files analyzed by formulating a search query.

The search module 6 therefore constitutes what is referred to as the “front end” of the device, i.e. that via which the end user interacts with the device, while the modules 1 to 5 constitute what is referred to as the “back end”, i.e. that which is not visible to the end user of the device.

The search module 6 can communicate with a video editor module 7, comprising an interface for creating, editing and viewing video excerpts corresponding to virtual sequences.

The search module 6 allows at least the user to formulate a search query and to view the result thereof.

When the server of the document-oriented database receives the query thus formulated in the client, a search, via keywords in particular, is carried out on the video file sequences by virtue of the association {primary index, secondary index} based on an inheritance relationship and by virtue of the sets of descriptors that have been associated with each sequence of each digital video file during the secondary indexing.

The query is not a query based on a relational database language, although this possibility can be envisaged. It is a query of the type used by search engines, namely that the query can combine a full-text search, a faceted search based on the descriptors present in the primary and secondary indexes, and a numerical search (for example, sorting can be performed based on chronological criteria).

The search query can be formulated by a user in a user interface or by a chatbot.

The search result is then displayed in the graphical interface of the search and editing module 6 and it takes the form not of a list of video files but of a list of video file sequences, classed in order of relevance.

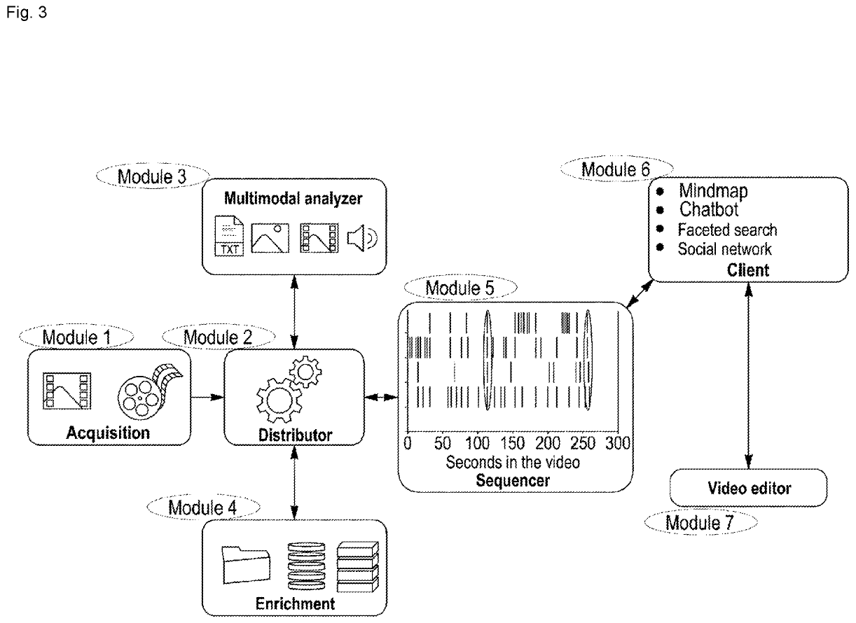

FIG. 3 shows the various interactions between the modules and services of the computerized method in conjunction with possible user actions.

The principle is therefore that implemented for website search engines, which make it possible to directly access the pages that make up the websites, or for the creation of playlists from a set of audio files in which tracks or chapters are predefined. However, while this principle is natural for these two types of media, which are highly structured and designed to be indexed, it is generally not used for any type of digital video file, for which the choice has historically been to index them in their entirety because of the complexity in sequencing them.

In summary, the device makes it possible to create an engine for searching for digital video file sequences, the sequencing of video files on which the search is performed being dynamic, i.e. created, modified or adapted at the end of the formulation of a new search query.

Thus, returning to the example of soccer matches, if the user wishes to obtain a video composed of all of the goals scored by Number 11 of the team that won Ligue 1 a given year in France, this is possible by virtue of the method described here, based just on the data of the complete video files for Ligue 1 matches in France without any manual intervention to select sequences in each of the video files.

In the field of online courses, it is even possible to create a video composed of video sequences taken from different video files, each relating to the subject of series expansion, but only selecting the portions of video files that relate to Taylor expansion. This represents a considerable saving in time, since it is no longer necessary to view all of the relevant video files when only portions (sequences) of these video files are actually relevant to the formulated search query.

The search result can comprise multiple sequences originating from multiple different video files and/or multiple sequences originating from the same digital video file.

It should also be noted that at least in the first case, the concept of time consistency between the video file sequences arising from the search is absent, which is far beyond the capabilities of current video search engines. The chaptering is thus chaptering across multiple digital video files.

The time consistency of the original sequences might not be respected, even in the case where the sequences forming the list returned in response to the search query come from the same original digital video file, since it is the relevance of the sequences with respect to the search criterion that determines their order of appearance in this list.

The relevance of the sequences with respect to the search criterion is, for example, evaluated according to logical and mathematical criteria, which allow a score to be assigned to each sequence according to a query. The sequences are then presented in decreasing order of score. Prior steps of filtering (language, geographical origin, dates, etc.) can be provided.

In one particular embodiment, during indexing, a higher weight is assigned to the secondary descriptors than to the primary descriptors so that the result of the search is more based on the content of the sequence than on the content of the digital video file in its entirety.

By virtue of the indexing architecture (primary and secondary), a user can therefore perform multiple tasks dynamically based on full-text search functionalities, semantic concepts, thematics or multicriteria facets/filters.

The search module 6 can comprise a user interface, such as a computer, a tablet or a smartphone, for example.

The video editor module 7 can comprise a user interface, such as a computer, a tablet or a smartphone, for example.

The user interface can be common to the modules 6 and 7.

The user can in particular, via any of these interfaces:
from each virtual sequence, extract the virtual sequence from the digital video file to produce a video excerpt that they can view, for example by streaming, or save in the form of a new digital video file. If a video excerpt is viewed, they can optionally simultaneously view the secondary and/or primary endogenous and/or, if applicable, exogenous descriptors associated with the extracted sequence.
Produce a summary from a video file (either via natural language processing for online courses, via by image recognition for a summary of sports sequences);
Create playlists by combining similar sequences and/or sequences that are in response to a query, these sequences potentially originating from different original video files and being organized in the playlist according to a criterion other than a time criterion;
Create a virtual montage by combining similar sequences and/or sequences that are in response to a query, these sequences potentially originating from different original video files and being organized in the playlist according to a criterion other than a time criterion;
Browse within the playlist or the new video thus created, since these are automatically chaptered by virtue of the secondary indexing system. In particular, it is possible to start playing a chapter as desired or else to pause and to resume the dynamic run-through of the video excerpts via an appropriate graphical interface.
Synchronize video extracts with a dashboard-style “second screen” presenting enriched information from metrics or statistics, derived from a calculation of indicators extracted from the video excerpts. The analysis of the data can then optionally be coupled with the video analysis. The dashboard can also feature other information, such as definitions or “find out more”, from an online encyclopedia, maps, graphs, . . . .

The user interface can comprise a graphical interface 55 comprising an area 52 dedicated to formulating the search query and displaying the results thereof, an area for viewing the video excerpts (screen 1, reference 53), a second display area (or screen 2, reference 54), synchronized with screen 1 and a virtual remote control area 51.

When a playlist has been obtained, in one particular embodiment, each sequence end marker of each virtual sequence associated with an excerpt from the playlist is:
a primary plurimodal sequence end marker, or
a secondary plurimodal sequence end marker resulting from three modalities.

This arrangement makes it possible to increase the semantic consistency of the playlist as a whole and its consistency with respect to the formulated search criterion.

Browsing can, by virtue of the primary and secondary indexing system, be extended outside the selected playlist: it is possible, for example, from a given sequence in the playlist, to extend the playback of the digital video file from which the sequence was taken beyond this sequence by moving the sequence start and/or sequence end markers.

Visual effects such as, non-exhaustively, slow motion, zoom, looping, etc., can be applied to the playlist, either during viewing, adding text, freeze frame, etc., or for editing a new digital video file.

Sound effects such as, non-limitingly, changing background sound, adding a comment or another sound, can be applied to the playlist, either during viewing, or for editing a new digital video file.

The creation of a playlist or the editing of a new video can be entirely automated based on the formulation of the search query. However, since the system behaves as a virtual read head which moves dynamically from sequence in sequence, the user can act on the playlist or the new video at any time if the graphical interface of the module 6 affords them the possibility.

In one embodiment, the graphical interface of the video editor module 7 offers browsing options in the form of an enhanced video player, allowing access to the summary when the search result is an entire video, or interactive highlights within selected and aggregated sequences.

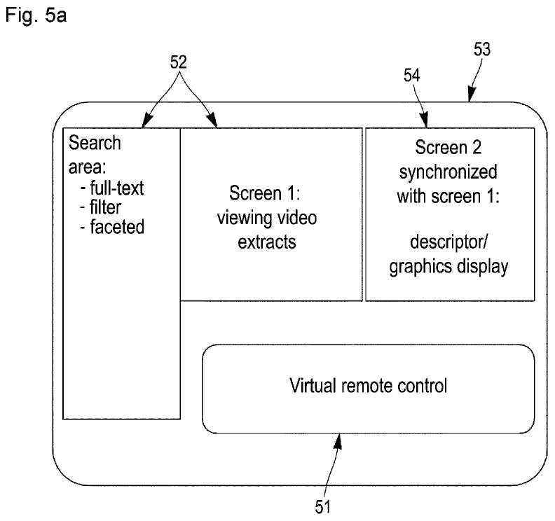

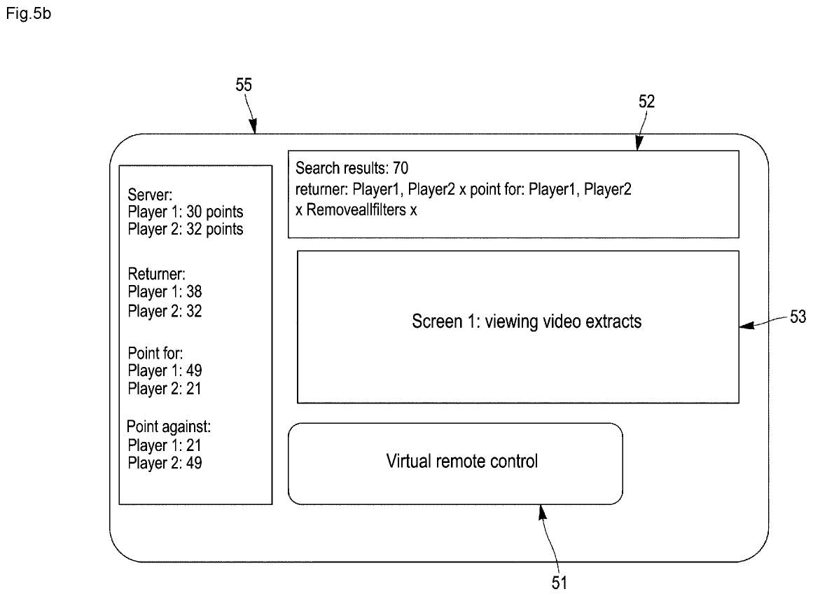

One embodiment of such a graphical interface 55, for editing or viewing a playlist, can be seen in FIG. 5a. Selectable descriptors are positioned to the left of screen 1 for viewing the playlist, the playlist can be displayed above the screen 1, the descriptors related to the user's search being displayed above the playlist. The virtual remote control 51 is located below the playlist. A second screen related to the video excerpt corresponding to the virtual sequence currently being viewed is located to the right of the playlist and allows graphics or other useful information related to the playlist to be displayed.

FIG. 5b shows another embodiment of the graphical interface of the device 8 wherein selectable descriptors are positioned to the left of the screen for viewing the playlist, the playlist is viewed in screen 1 (reference 53), the descriptors related to the user's search are located above the playlist and the virtual remote control 51 is located below the playlist

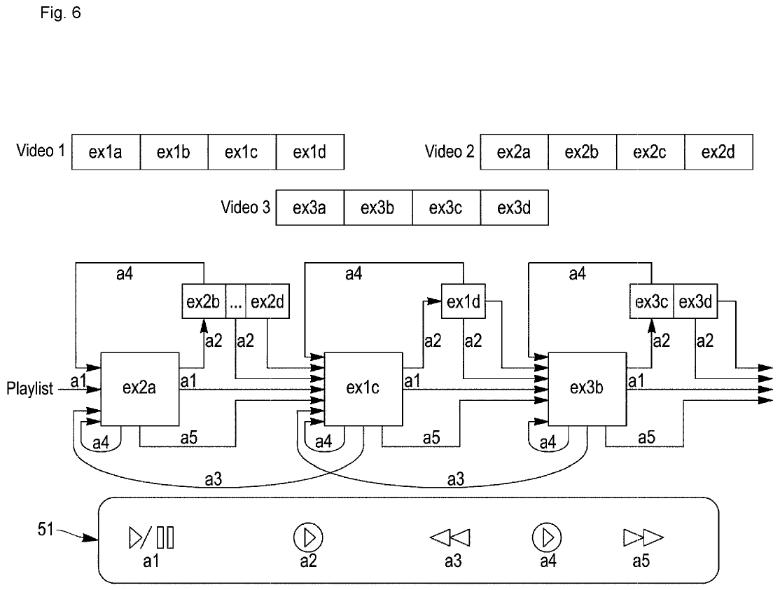

FIG. 6 shows the actions carried out when each button of the virtual remote control is used on an exemplary playlist created from three digital video files, the playlist being formed, by way of example, of three different excerpts.

The virtual remote control comprises at least 5 virtual buttons, for example.

Button a1 allows the video excerpt corresponding to the current sequence to be viewing and viewing to be stopped.

When button a2 is pressed, the playback of the video excerpt corresponding to the sequence being viewed will be extended in the original digital video file beyond the duration provided for this sequence; pressing button a2 a second time before viewing has exceeded the time limit provided for the sequence cancels the first press of button a2; pressing button a2 a second time while viewing the digital video file outside the provided time limit stops the viewing of the original digital video file and resumes the playlist in the next sequence.

Button a3 goes back to the start of the sequence preceding the sequence currently being viewed.

Button a4 goes back to the start (to the time code of the start marker) of the sequence currently being viewed.

Button a5 stops the viewing of the current sequence and initiates playback of the next sequence.

It is possible for other virtual buttons to be added:
A (“−N s”) button, which makes it possible to go N seconds back in the digital video file of the current sequence, allowing a sequence to be watched again or making it possible to view N seconds before the start marker of the current virtual sequence;
A (“+Ns”) virtual button, this button making it possible to go N seconds forward in the digital video file of the current sequence, allowing a sequence to be skipped or making it possible to view 10 seconds after the end marker of the current virtual sequence.

The virtual buttons allow interaction with the sequence start and end markers in the background.

The virtual remote control therefore allows flexible browsing within the automatic playlist of video excerpts from digital files, the user being free to view the selected excerpts in the order of the playlist or in an order that is better suited to them, or even to extend the viewing of an excerpt beyond the start and end cut markers, and do so without the files associated with each excerpt being created and having to be opened and/or closed to go from one excerpt to another. Browsing convenience and possibilities are therefore considerably enhanced with respect to what is possible with a “static” playlist in the sense of the prior art.

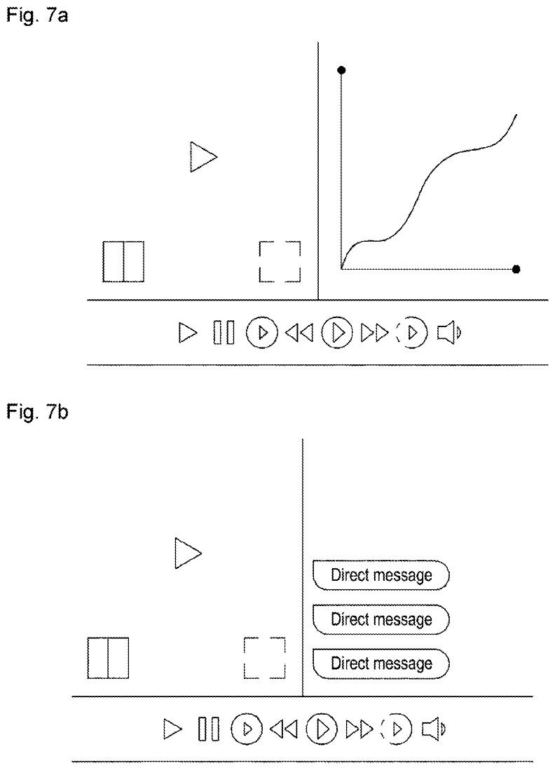

FIG. 7a and FIG. 7b show two examples of a graphical interface 55.

FIG. 7a shows a graphical interface of the computerized method, comprising a first screen 53 for viewing the playlist, a second screen 54 for a graph related to the sequence currently being viewed and a virtual remote control 51 located below the two screens for browsing through the playlist (in which the video excerpts are arranged one after the other), and a button for making the playlist full-screen.

FIG. 7b shows a graphical interface 56 of the computerized method, comprising a first screen 53 for viewing the playlist, a second screen 54 for displaying messages related to the video or for communicating with other users, a virtual remote control 51 located below the two screens for browsing through the playlist, and a button for making the playlist full-screen.

When a search result comprises only virtual sequences identified from one and the same digital video file, the playlist consisting of excerpts based on this search result can be exhaustive.

It can also contain only those excerpts considered essential with respect to search criteria specified by the user.

In particular, a score can be defined in order to classify the virtual sequences of digital video files into two categories: “essential” and “accessory” depending on the number of descriptors found.

When a search result comprises virtual sequences from different digital video files, the playlist consisting of excerpts based on this search result can contain only excerpts associated with virtual sequences that are identified as essential with respect to search criteria specified by the user.

The concept of summary can be defined with respect to a particular field. In the case of sport, and in particular soccer, the summary can be constructed from keywords provided by the user or defined beforehand, for example {goal, card yellow, red card, player substitution, half-time}, the relevant sequences being presented in the time order of the initial digital video file from which they come.

It is possible to browse this playlist or the new video by selecting or deselecting certain scenes, for a real-time video montage, for example through a graphical interface comprising a menu bar and control buttons that can be actuated via mouse click, such as “play”, “fast forward”, “stop”, “chapter selection”, . . . .

The search is possible in “full-text” mode and in “faceted” search mode, optionally with semi-automatic input. The faceted responses allow the search criteria to be refined and are combined with full-text words.

For example, for the example of the field of soccer, it is possible to produce a playlist comprising corner goals from all of the teams in Ligue 1 in France for one year at home in the last ¼ hour of the match in approximately 10 times less time than this would take on a professional platform (InStat/Dartfish/Sportscode coupled with the Opta/Bombstats data providers), and the playlist is composed only of relevant match sequences and not of the entire matches.

By virtue of the inheritance-based indexing system, the video files (the matches in the preceding example) from which the sequences come are known. It is therefore possible to provide an option for partially or completely viewing the original video files of the sequences if necessary.

The interfacing between the “front-end” module 6 and the “back end” composed of modules 1 to 5 can take place regardless of the medium for module 6 (computer, tablet, smartphone, etc.) optionally without the need for a proprietary application. This can be achieved in particular with open-source technologies, such as the JavaScript React library.

Optionally, the device can be integrated into a social network, and offer two user profiles: video file creators who create files by editing by means of the video editor module 7 and viewers (followers) who follow these creators.

The browsing history for a playlist of excerpts from digital video files obtained according to the invention can be recorded. It can then be shared in a social network or used to semi-automatically edit a new digital video file.

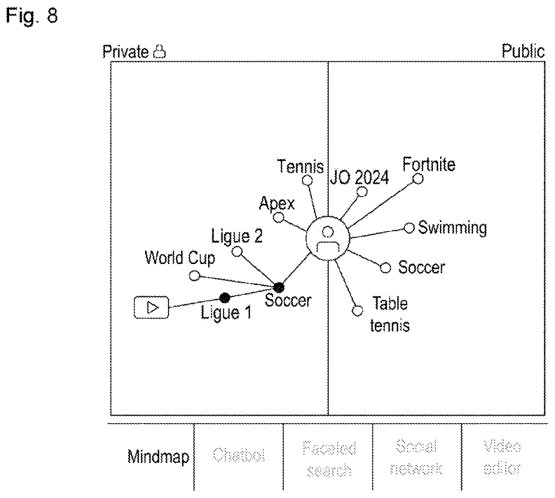

FIG. 8 shows a graphical interface of the device 8 comprising a screen for showing a mindmap of a directory of sequences, automatic lists, extracts or playlists recorded by the user, with some of the recordings being public and others private; below this screen, several tabs can be selected: Mindmap, Chatbot, Faceted search, Social network and Video editor.

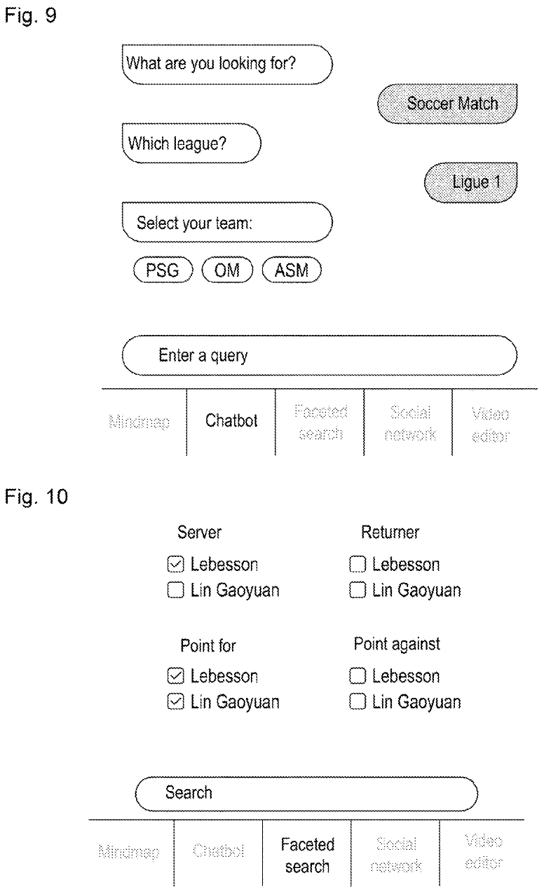

FIG. 9 shows a graphical interface 56 of the device 8, comprising a screen for showing the interactive chatbot allowing a playlist or sequence search to be carried out via a keyword chat; below this screen, several tabs can be selected: Mindmap, Chatbot, Faceted search, Social network and Video editor.

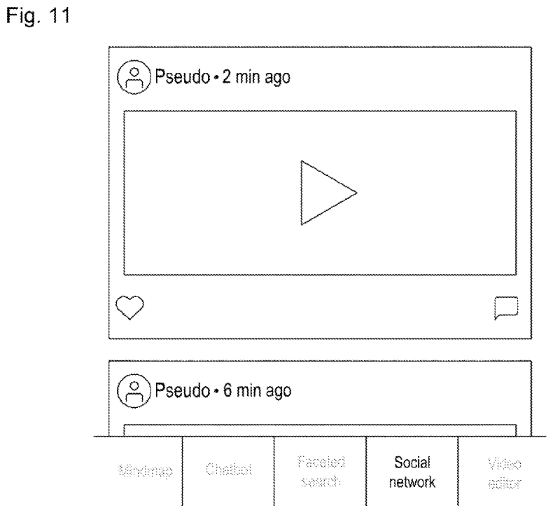

FIG. 10 shows a graphical interface of the device 8, comprising a screen for showing the faceted search, grouping descriptors together under other more general descriptors, allowing a tree search; below this screen, several tabs can be selected: Mindmap, Chatbot, Faceted search, Social network and Video editor.

FIG. 11 shows a graphical interface of the device 8, comprising a screen for the social network integrated into the invention; users share found or created playlists; below this screen, several tabs can be selected: Mindmap, Chatbot, Faceted search, Social network and Video editor.

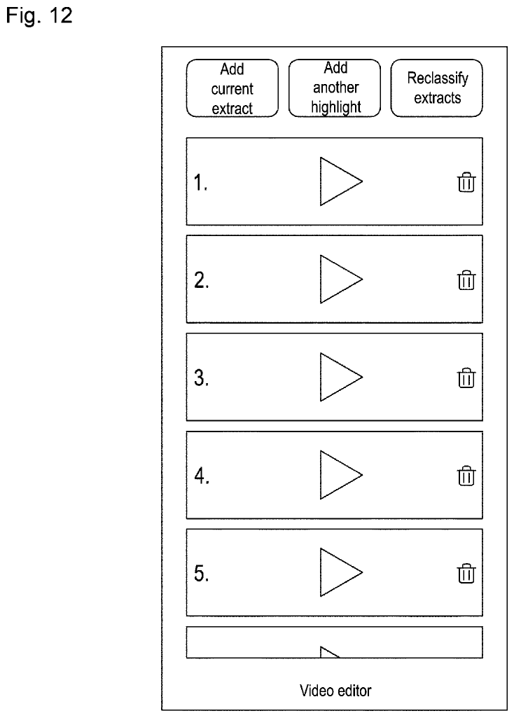

FIG. 12 shows a graphical interface of the computerized device 8, comprising a screen for video editing; the user can change the order of the excerpts and incorporate the excerpts that they want into a playlist; below this screen, several tabs can be selected: Mindmap, Chatbot, Faceted search, Social network and Video editor.

### LIST OF REFERENCE SIGNS

1: acquisition module
2: distribution module
3: multimodal analysis module
3a: image modality analyzer
3b: audio modality analyzer
3c: text modality analyzer
3d: action modality analyzer
4: enrichment module
4a: open-data database
4b: web services
4c: other database type
5: sequencer module
6: client
7: video editor module
8: computerized device for sequencing digital video files
21: primary plurimodal candidate sequence marker
22: three-modality secondary plurimodal candidate sequence marker
23: two-modality secondary plurimodal candidate sequence marker
51: virtual remote control
52: area dedicated to formulating the search query and displaying the results thereof
53: area for viewing the video excerpts (screen 1)
54: display area synchronized with screen 1
55: graphical user interface

1.-38. (canceled)

39. A computerized method for the audiovisual delinearization of original digital video files, which is intended for viewing video excerpts from these original video files, the method comprising: the sequencing thereof into virtual sequences, indexing of the virtual sequences in a secondary index, by automatically and virtually cutting the original digital video files into virtual sequences by means of time marking, and indexing the original video files in a primary index,
each virtual sequence being bounded by two sequence time markers each corresponding to a time code of the original video file and associated descriptors,
the duration of each virtual sequence being comprised between a minimum duration and a maximum duration defined for all of the digital video files of the same field,
the method comprising the following steps:
a. receiving the original digital video files to be analyzed and storing them in a document-oriented database;
b. initial indexing of each of said original digital video files in a primary index by means of initial first descriptors that are associated with each original digital video file and allow it to be identified;
c. automatically extracting audio, image, and text data streams from each of said original digital video files;
d. by means of a multimodal analysis module comprising a plurality of computerized devices with a plurality of neural networks selected and/or trained for a previously defined original digital video file field, automatically analyzing, file by file, each of said original digital video files, according to the four modalities: image modality, audio modality, text modality, and action modality for identifying groups of successive images forming a given action, the multimodal analysis automatically producing one or more unimodal cut time markers for each of the modalities, one or more descriptors being associated with each of the unimodal cut time markers,
e. by means of a sequencer module connected to the distribution module which is itself connected to the multimodal analysis module, automatically producing, at the end of the multimodal analysis of each of said original digital video files, candidate sequence time markers, with the aim of bounding virtual sequences during a search, and descriptors associated with these candidate sequence time markers, which are:
either unimodal cut time markers of said original digital video files, and which are referred to, at the end of this step, as unimodal candidate sequence time markers;
or, for each of said original digital video files taken individually, the time codes corresponding to said unimodal cut time markers are compared and, each time at least two unimodal cut time markers resulting from different analysis modalities are separated by a time interval less than a main predetermined duration, a plurimodal candidate sequence time marker, having a time code dependent on the time codes of the at least two unimodal cut markers, is created;
f. for each of said analyzed original digital video files, according to a defined lower bound and upper bound for determining the minimum duration and the maximum duration of each virtual sequence from the original digital video files in the defined original digital video file field, with respect to the field of the original digital video files,
automatically selecting, from among the unimodal or plurimodal candidate sequence time markers, pairs of virtual sequence time markers to form virtual sequences during a search,
each pair of virtual sequence time markers having a sequence start time marker and a sequence end time marker, such that the duration of each retained virtual sequence is comprised between said lower and upper bounds,
the duration of the virtual sequences of the digital video files of the same field having one and the same minimum duration and one and the same maximum duration,
these sequence start or sequence end time markers being either unimodal or multimodal depending on the markers found between the upper bound and the lower bound, these pairs of virtual sequence markers being associated with the descriptors automatically generated by the multimodal analysis module (3) and associated with said selected candidate sequence time markers,
these descriptors then being referred to as “secondary descriptors” and allowing each virtual sequence to be searched,
some of the descriptors automatically generated by the multimodal analyzer throughout the original digital video file according to the four modalities being referred to as “primary descriptors” and characterizing each video file in question in a general manner,
g. indexing the original digital video files in the primary index by adding, to the initial first descriptors, primary descriptors generated automatically by the multimodal analysis according to the four modalities throughout the original digital video files,
storing and indexing, in a secondary index which is in an inheritance relationship with respect to said primary index, all of the pairs of virtual sequence time markers with the associated secondary descriptors resulting from the multimodal analysis allowing each sequence to be identified,
the virtual sequences being identifiable and searchable at least by the secondary descriptors generated by the multimodal analysis and the primary descriptors generated by the multimodal analysis.

40. The computerized method for audiovisual delinearization according to claim 39, wherein descriptors of a generic nature feed the primary index from the secondary index, and descriptors initially identified as generic but which become relevant to a particular virtual sequence feed the secondary index from the primary index.

41. The computerized method for audiovisual delinearization according to claim 39, wherein the primary and secondary indexes are multiple-field indexes and feed each other.

42. The computerized method for audiovisual delinearization according to claim 39, wherein before the sequencing of a original digital video file, there is a step of enriching the primary descriptors resulting from the multimodal analysis of this digital video file with exogenous descriptors, also referred to as primary exogenous descriptors, by means of the enrichment module, the one or more original digital video file therefore being indexed in the primary index by means of primary descriptors resulting from the multimodal analysis, and from outside the multimodal analysis.

43. The computerized method for audiovisual delinearization according to claim 39, wherein at least one additional step of enriching the indexing of the virtual sequences with exogenous secondary descriptors is carried out in step g.

44. The computerized method for audiovisual delinearization according to claim 39, wherein video excerpts, each associated with a virtual sequence, obtained by viewing the original digital video file fragment between the two sequence markers of the virtual sequence, each have a unit of meaning which results from the automatic analysis of each original digital video file according to the four modalities and the virtual cutting with respect to this analysis, the analysis according to the text modality allowing the virtual sequences to be cut by cutting according to speech analysis models of the sentences and/or paragraphs of the speech in the original digital video files into units of meaning reflecting a change of subject or the continuation of an argument based on automatic language processing algorithms implemented on the text which follows a speech-to-text transcription algorithm.

45. The computerized method for audiovisual delinearization according to claim 39, wherein at least one of the two sequence markers of each pair of sequence markers selected in step f is a plurimodal candidate sequence time marker and is then referred to as a plurimodal sequence marker, and advantageously each sequence marker of each selected pair of sequence markers is a plurimodal sequence marker.

46. The computerized method for audiovisual delinearization according to claim 39, wherein the method allows to distinguish between descriptors resulting from the multimodal analysis which are underpinned by a single modality from those which are underpinned by multiple modalities, the secondary descriptors resulting from the multimodal analysis are referred to as “unimodal” when they correspond to a single modality and are referred to as “plurimodal” when they are detected for multiple modalities.

47. The computerized method for audiovisual delinearization according to claim 39, wherein step f has these sub-steps, for each original digital video file, for producing the virtual sequences:
i) —automatically selecting a last sequence end time marker, which is in particular plurimodal, from the end of the original digital video file,
and determining the presence of a plurimodal time marker of which the time code is comprised between two extremal time codes, which are calculated by subtracting the lower bound from the time code of the selected sequence end time marker and by subtracting the upper bound from the time code of the selected sequence end time marker,
automatically selecting the plurimodal time marker as the last sequence start time marker if the presence thereof is confirmed,
otherwise, automatically determining the presence of a unimodal time marker of which the modality is dependent on the field of the original digital video file between the two extremal time codes,
selecting the unimodal time marker as the last sequence start time marker if the presence thereof is confirmed,
otherwise, the last sequence start time marker is designated by subtracting the upper bound from the time code of the selected last sequence end time marker;
ii) automatically reiterating step i) to select a penultimate sequence start time marker,
the sequence start time marker selected at the end of the preceding step i acting as the last sequence end time marker selected at the start of the preceding step i;
iii) automatically reiterating sub-step ii) and so on until the start of the original digital video file.

48. The computerized method for audiovisual delinearization according to claim 39, wherein said maximum duration of each selected sequence is equal to or less than two minutes, 1 minute or 30 seconds

49. The computerized method for audiovisual delinearization according to claim 39, wherein the secondary descriptors by means of which the identified sequences are indexed are enriched with a number or letter indicator, such as an overall score of a digital collection card, calculated for each virtual sequence based on the secondary descriptors of the sequence and/or the primary descriptors of the original digital video file in which the sequence was identified,
the score being configured to allow the virtual sequences from original digital video files to be classified according to two categories, referred to as “essential” and “accessory”, depending on the number of associated secondary descriptors, and the results of a subsequent virtual sequence search to be ordered.

50. The computerized method for audiovisual delinearization according to claim 39, wherein the action modality analyzer detects:
in a first step, scene breaks;
in a second step, the information returned by the image modality analyzer is analyzed in the action modality analyzer by an action detection algorithm which has a dense pose estimation system that associates the pixels of two successive images based on the intensities of the different pixels in order to match them with one another, so as to perform “video tracking” without sensors having been positioned on the moving objects/subjects present in the video content, in particular with a view to detecting parts of the human body,
the action modality analyzer additionally using sounds associated with images such as interruptions in the flow of a speaker.

51. The computerized method for audiovisual delinearization according to claim 39, wherein the method for audiovisual delinearization is implemented in the case of an unstructured digital video file, such as those generally available on the Internet or used in “multicast” broadcast methods, such as YouTube® videos for example.

52. The computerized method for audiovisual delinearization according to claim 39, wherein the technology used is ElasticSearch.

53. A computerized method for automatically producing an ordered playlist of video excerpts from original digital video files, with a data transmission stream,
the original digital video files having previously been delinearized by means of the computerized method for audiovisual delinearization according to claim 39,
on the basis of storage, in the document-oriented database with the primary-secondary double indexing in an inheritance relationship:
of the one or more original digital video files, with their initial first descriptors and primary descriptors generated automatically by the multimodal analysis,
of all of the pairs of virtual sequence time markers of the original video files, and secondary descriptors generated automatically during the multimodal analysis,
each virtual sequence therefore being searchable not only on the basis of the secondary descriptors which characterize it but also on the basis of the primary descriptors which characterize the original digital video file of which it is a “daughter”, via the inheritance relationship between the primary index and the secondary index, the method for producing a playlist comprising:
1. formulating at least one search query;
2. transmitting said search query to a search server associated with said database;
3. determining and receiving, via the document-oriented database of said server, in response to said transmitted search query, the search result which is an automatic list of pairs of sequence time markers and associated descriptors generated automatically during the multimodal analysis at the same time as the time markers, in an order which is dependent on the descriptors associated with each virtual sequence and the formulation of the search query,
the virtual sequences being identifiable and searchable by the secondary descriptors and the primary descriptors generated automatically during the multimodal analysis,
each virtual sequence having a sequence start marker and a sequence end marker which are selected so that the duration of each retained virtual sequence is comprised between said lower and upper bounds, defined during sequencing, with respect to the field of the original digital video files, allowing each virtual sequence to have a duration comprised between one and the same minimum duration and one and the same maximum duration,
4. displaying and viewing, via a virtual remote control, the playlist which presents all of the video excerpts associated with the ordered automatic list of pairs of virtual sequence time markers received in step 3, the duration of each retained virtual sequence being comprised between one and the same minimum duration and one and the same maximum duration defined during the sequencing,
without creating a new digital video file, the virtual remote control allowing the playlist to be browsed,
each video excerpt of the playlist:
being associated with a virtual sequence, and
being called up during the viewing of the playlist, via the data transmission stream, from the original digital video file indexed in the primary index and in which said virtual sequence indexed in the secondary index was identified, the virtual sequence being found in the automatic list of step 3, the viewing of the video excerpt not requiring the creation of a new digital video file and directly calling up the corresponding passage from the stored original digital video file by virtue of the primary indexing being in an inheritance relationship with the secondary indexing,
the user being able to view, via the virtual remote control, the selected excerpts in the order of the playlist or in an order that is better suited to them, and do so without the files associated with each excerpt being created and having to be opened and/or closed to go from one excerpt to another.

54. The computerized method for automatically producing an ordered playlist of video excerpts from original digital video files according to claim 53, wherein the method allows the following browsing operation via the virtual remote control and the data transmission stream:
a) temporarily exiting the excerpt in the playlist which comprises all of the video excerpts in order to view the original digital video file of the excerpt without time constraints due to the start and end time markers of the virtual sequence associated with the video excerpt, the virtual remote control making it possible to extend the viewing of an excerpt beyond the start and end cut time markers, and to do so without video files associated with each video excerpt being created, and then to return to the playlist,
the user, via the virtual remote control, extends the viewing of an excerpt beyond the start and end cut markers, and do so without files associated with each excerpt being created and having to be opened and/or closed to go from one excerpt to another.

55. The computerized method for automatically producing an ordered playlist of video excerpts from original digital video files according to claim 54, wherein the method allows the following additional operation:
b) again temporarily exiting the viewing of the original digital video file from the excerpt currently being played back since operation a), in order to view, in step b), a summary created automatically and prior to this viewing on the basis of this original digital video file only.

56. The computerized method for automatically producing an ordered playlist of video excerpts from original digital video files according to claim 53, wherein said search query formulated in step 1 is a multicriteria search query, and combines a full-text search and a faceted search, and wherein the criteria for creating the order for said automatic playlist comprise chronological and/or semantic and/or relevance criteria.

57. The computerized method for automatically producing an ordered playlist of video excerpts from original digital video files according to claim 53, wherein:
when the pairs of virtual sequence time markers constituting the automatic list are identified in a single original digital video file, the method produces, via the transmission stream, a summary playlist with a selection of video excerpts from this original digital video file according to criteria specified by the user during their search,
when the pairs of virtual sequence time markers constituting the automatic list are identified in multiple digital video files of different origin, the method produces, via the transmission stream, a playlist of video excerpts that are associated with the virtual sequences, referred to as “highlights” of these digital files with a selection of the video excerpts according to criteria specified by the user during their search.

58. The computerized method for automatically producing an ordered playlist of video excerpts from original digital video files according to claim 53, wherein the method accesses the video files in “streaming” mode.

59. A computerized editing method with virtual cutting without creation of a new digital video file, based on the computerized method for automatically producing an ordered playlist of video excerpts from original digital video files according to claim 53, comprising the following steps:
I. automatically producing at least one first ordered playlist of video excerpts from original digital video files and storing the at least one automatic list of pairs of sequence time markers and associated descriptors resulting from this production step, without creating a digital video file;
II. browsing the first automatic playlist of video excerpts from original digital video files via data transmission stream;
III. the user selecting one or more virtual sequences associated with the first automatic playlist of video excerpts from original digital video files, to produce a new playlist of video excerpts of which the order is modifiable by the user.

60. The computerized editing method with virtual cutting according to the preceding claim, comprising the following step:
modifying, in the new playlist, one or more video excerpts by extending or shortening the duration of the virtual sequences that are associated with the video excerpts of said new playlist, by moving the start and end time markers of each virtual sequence.

61. A computerized system comprising:
i. At least one acquisition module for acquiring one or more digital video files;
ii. At least one distribution module;
iii. At least one multimodal analysis module;
iv. At least one sequencing module which generates indexed sequences of digital video files;
v. At least one search module comprising a client which allows a search query to be formulated,
in order to implement the following steps:
1. via the acquisition module, receiving the original digital video files to be analyzed and storing them in a document-oriented database;
2. indexing each of said original digital video files in a primary index by means of initial first descriptors that are associated with each original digital video file and allow it to be identified;
3. automatically extracting audio, image, and text data streams from each of said original digital video files;
4. by means of a multimodal analysis module comprising a plurality of computerized devices with a plurality of neural networks selected and/or trained for a previously defined original digital video file field, automatically analyzing, file by file, each of said original digital video files, according to the four modalities: image modality, audio modality, text modality, and action modality for identifying groups of successive images forming given actions, the multimodal analysis automatically producing one or more unimodal cut time markers for each of the modalities, one or more descriptors being associated with each of the unimodal cut time markers,
5. by means of a sequencer module connected to the distribution module which is itself connected to the multimodal analysis module, automatically producing, at the end of the multimodal analysis of each of said original digital video files, candidate sequence time markers, with the aim of bounding virtual sequences during a search, and descriptors associated with these candidate sequence time markers, which are:
either unimodal cut time markers of said original digital video files, and which are referred to, at the end of this step, as unimodal candidate sequence time markers;
or, for each of said original digital video files taken individually, the time codes corresponding to said unimodal cut time markers are compared and, each time at least two unimodal cut time markers resulting from different analysis modalities are separated by a time interval less than a main predetermined duration, a plurimodal candidate sequence time marker, having a time code dependent on the time codes of the at least two unimodal cut markers, is created;
6. for each of said analyzed original digital video files, according to a defined lower bound and upper bound for determining the minimum duration and the maximum duration of each virtual sequence from the original digital video files in the defined original digital video file field, with respect to the field of the original digital video files,
automatically selecting, from among the unimodal or plurimodal candidate sequence time markers, pairs of virtual sequence time markers to form virtual sequences during a search,
each pair of virtual sequence time markers having a sequence start time marker and a sequence end time marker, such that the duration of each retained sequence is comprised between said lower and upper bounds, these sequence start or sequence end time markers being either unimodal or multimodal depending on the markers found between the upper bound and the lower bound,
these pairs of sequence markers being associated with the descriptors automatically generated by the multimodal analysis module and associated with said selected candidate time markers,
these descriptors then being referred to as “secondary descriptors” and allowing each virtual sequence to be searched,
some of the descriptors automatically generated by the multimodal analyzer throughout the original digital video file according to the four modalities being referred to as “primary descriptors” and characterizing each video file in question in a general manner,
7. indexing the original digital video files in the primary index by adding, to the initial first descriptors, primary descriptors generated automatically by the multimodal analysis according to the four modalities throughout the original digital video files,
storing and indexing, in a secondary index which is in an inheritance relationship with respect to said primary index, all of the pairs of virtual sequence time markers with the associated descriptors resulting from the multimodal analysis allowing each sequence to be identified,
the virtual sequences being identifiable and searchable at least by the secondary descriptors generated by the multimodal analysis and the primary descriptors generated by the multimodal analysis,
the primary-secondary indexing in an inheritance relationship allowing video excerpts from the original video files to be viewed from these original video files, without creation of a new digital video file,
each virtual sequence being intended for viewing a video excerpt from the original video file from which the sequence originates, based on viewing this original video file between the two time markers of this sequence,
each stored pair of markers having a sequence start marker and a sequence end marker which are selected so that the duration of each searched sequence from the original digital video files is comprised between said lower and upper bounds defined for the original digital video file field so that the duration of each virtual sequence is comprised between one and the same minimum duration and one and the same maximum duration,
8. A search query is formulated for searching an ordered playlist of video excerpts from original digital video files, by means of the search module;
each of said modules: acquisition module, distribution module, multimodal analysis module, enrichment module, sequencing module, search module comprising the necessary computing means,
each of said modules: acquisition module, multimodal analysis module, sequencing module, search module communicating with said distribution module and said distribution module managing the distribution of the calculations between said modules,
8. Create, edit and view video excerpts corresponding to virtual sequences via a video editor module.

62. A computerized system according to claim 61, wherein the video editor module comprises a virtual remote control which is configured to view the playlist which presents all of the video excerpts associated with the ordered automatic list of pairs of virtual sequence time markers received in step 8, the duration of each retained virtual sequence being comprised between one and the same minimum duration and one and the same maximum duration defined during the sequencing,
without creating a new digital video file, the virtual remote control allowing the playlist to be browsed,
each video excerpt of the playlist:
being associated with a virtual sequence, and
being called up during the viewing of the playlist, via the data transmission stream, from the original digital video file indexed in the primary index and in which said virtual sequence indexed in the secondary index was identified, the virtual sequence being found in the automatic list of step 3, the viewing of the video excerpt not requiring the creation of a new digital video file and directly calling up the corresponding passage from the stored original digital video file by virtue of the primary indexing being in an inheritance relationship with the secondary indexing,
the user being able to view, via the virtual remote control, the selected excerpts in the order of the playlist or in an order that is better suited to them, and do so without the files associated with each excerpt being created and having to be opened and/or closed to go from one excerpt to another.

63. A computerized system according to claim 62, wherein the virtual remote is configured to:
a) temporarily exiting the excerpt in the playlist which comprises all of the video excerpts in order to view the original digital video file of the excerpt without time constraints due to the start and end time markers of the virtual sequence associated with the video excerpt, the virtual remote control making it possible to extend the viewing of an excerpt beyond the start and end cut time markers, and to do so without video files associated with each video excerpt being created, and then to return to the playlist,
the user, via the virtual remote control, extends the viewing of an excerpt beyond the start and end cut markers, and do so without files associated with each excerpt being created and having to be opened and/or closed to go from one excerpt to another.

64. A computerized system according to claim 61, wherein the video editor module is configured to:
automatically produce at least one first ordered playlist of video excerpts from original digital video files and storing the at least one automatic list of pairs of sequence time markers and associated descriptors resulting from this production step, without creating a digital video file;
browse the first automatic playlist of video excerpts from original digital video files via data transmission stream;
select one or more virtual sequences associated with the first automatic playlist of video excerpts from original digital video files, to produce a new playlist of video excerpts of which the order is modifiable by the user.
modify, in the new playlist, one or more video excerpts by extending or shortening the duration of the virtual sequences that are associated with the video excerpts of said new playlist, by moving the start and end time markers of each virtual sequence.
